(19) United States
(12) Patent Application Publication
(10) Pub. No.: US 2026/0237297 A1
(43) Pub. Date: Aug. 13, 2026

(54) SMART TRAFFIC MANAGEMENT SYSTEM

(71) Applicant: Alebiosu Enterprises LLC, Norwalk, CT (US)

(72) Inventor: Brian Alebiosu, Norwalk, CT (US)

(73) Assignee: Alebiosu Enterprises LLC, Norwalk, CT (US)

(21) Appl. No.: 19/454,558

(22) Filed: Jan. 21, 2026

Related U.S. Application Data
(60) Provisional application No. 63/750,801, filed on Jan. 29, 2025.

(51) Int. Cl. G08G 1/083; G08G 1/01; G08G 1/017

(52) U.S. Cl. CPC G08G 1/083; G08G 1/0116; G08G 1/0133; G08G 1/017

(57) ABSTRACT

An adaptive traffic management system including at least one sensor at a road segment for determining vehicle information on a series of road segments and a processor in communication with the at least one sensor. The processor is configured to create an initial geospatial grid with a tier road classification, process data communicated by the at least one sensor of vehicle information on the series of road segments, calculate vehicle status of the series of roads based on predetermined vehicle capacities and adjust select traffic lights on a select series of roads in accordance with calculation and predictive evaluations. The system can include validations to assess accuracy of real time calculated outcomes. The system can also include self learning to enhance predictive inputs.

This application claims priority to provisional application 63/750,801, filed Jan. 29, 2025, the entire contents of which are incorporated herein by reference.

### BACKGROUND OF THE INVENTION

### Field of the Invention

This application relates to a smart traffic management system, and more particularly, to a traffic management system encompassing a series of traffic lights and sensor stations for gathering data in an operational environment and a data processor working together to reduce traffic/congestion.

### Background of Related Art

The current smart traffic management market offers a robust and versatile range of features and products. Products include management solutions that integrate a diverse range of data sources to allow for traffic optimization, incident detections, monitoring of intersections, tools to assist in law enforcement and emergency vehicle prioritization. These products include data analytics software for traffic and infrastructure, sophisticated sensors, advanced cameras, and AI integrated video feeds. However, each of the current products/systems suffers from drawbacks and deficiencies, and a need exists for improvements to such systems. Examples of some of these deficient systems are provided below.

Inrix AI Traffic has a system incorporating software that uses AI combined with several data points collected from connected cars, mobile phones, weather, and historical traffic to provide a) instantaneous updates to traffic conditions; and b) pinpointed traffic speeds in different lanes to deliver the most accurate ETAs on the road. This system is limited since although it provides instantaneous traffic updates and traffic speed, it does not provide preemptive plans of actions. That is, although the system helps with ETA's by alerting drivers, it does not make any adjustments to traffic patterns. Further, the sensors utilized in the system are limited in the data gathering.

Vision Mind (based in Milan, Italy) provides a smart video analysis platform which uses deep learning and AI-based algorithms to detect and monitor traffic congestion, accidents, and violations. The Vision Mind system can process video data from multiple surveillance cameras, allowing for large scale analysis of traffic patterns, enforcement, and safety. It can issue real time alerts to city traffic management systems or law enforcement for rapid response. However, the Vision Mind System is limited since in relies solely on surveillance cameras for its analysis, and lacks sensors to detect a variety of other parameters and conditions which enable better traffic detection and control.

Gridsmart (Based in Knoxville, Tennessee) provides a system utilizing a FE3-Bell Camera which is a high definition camera for horizon to horizon intersection detection, intended to reduce installation time and increase safety. It captures wide-angle imagery that is processed by the Gridsmart's software for immediate action. The Gridsmart system though is limited in its views of targeted locations, and lacks a comprehensive system of various parameters/conditions effecting driving conditions and processing such sensed parameters/conditions to assess and enable altering of traffic patterns.

Quantum Inventions (based in Singapore) has a product called TRIP which can take in data from multiple traffic flow sources, multiple journalistic information sources, and can combine other driver-related information, such as parking availability and urban road pricing. All this data is then converted to an internal representation being merged and fused into a single, unified situation picture. This situation picture can then be exported out in multiple outport formats. The TRIP System however is a traffic information platform product and not a traffic management system. Additionally, the TRIP Systems does not provide a wide range of sensors to detect various other conditions which affect traffic and congestion.

Notraffic (based in Tel Aviv, Israel) provides a system wherein data from connected vehicles (via DSRC or C-V2X) is merged with sensor data to enhance traffic signal optimization and respond to real-time traffic conditions. This integration allows for prioritizing emergency vehicles and public transit, reducing accidents and improving overall traffic flow. Traffic signals are dynamically adjusted based on real-time data from sensors, with the intent to improve traffic flow across the city. The system's AI continuously learns and adapts to changing traffic patterns intending to provide minimal delays and efficient route management. The system also uses a plug in play model for cameras and the traffic lights and controllers to help with future implementation of smart traffic management systems and smart traffic lights. However, the Notraffic system does not provide a comprehensive view of the targeted location, due in part to its limited sensors.

The need exists for an improved traffic management system that can provide a comprehensive array of sensors for sensing a variety of conditions for feeding to a processing system that can not only convey current traffic conditions but can effect key adjustments to traffic patterns and conditions as they arise.

### SUMMARY OF THE INVENTION

The present invention overcomes the problems and deficiencies of the prior art. The present invention provides a smart adaptive traffic management system that has large scale use, e.g., use on a citywide scale. With its smart traffic lights and standalone sensors, multi-tiered road segmentation, road segment capacity scaling, system validation and AI adaptations, the traffic system of the present invention provides an accurate and efficient system that also has predictive capabilities to control traffic in advance of potential buildup. How this is uniquely achieved is described in detail below.

The data from the sensors is transmitted to a cloud based platform through a wireless communication, such as cellular, Wi-Fi, Bluetooth, etc., where it is processed and analyzed by the unique software and algorithms of the present invention, and thereafter sent to traffic management systems for adjustment of traffic light signals. This is described in further detail below.

In some embodiments, the processing components can additionally include one or more of a) real time integration to historical data to view historic video data, b) detection of emergency vehicles and reactive light adjustment to provide a traffic flow path, c) weather/environment reactive analysis to adjust to weather effects, d) vehicle incident/accident detect and/or e) reactive adjustments.

In accordance with one aspect of the present invention, an adaptive traffic management system is provided comprising a plurality of sensors at a series of road segments for determining vehicle information on the series of road segments and a processor in communication with the sensors. The processor is configured to create an initial geospatial grid with a tier road classification, process data communicated by the sensors of vehicle information on the series of road segments, calculate vehicle status of the series of road segments based on predetermined vehicle capacities and adjust select traffic lights on a select series of road segments in accordance with calculation and predictive evaluations.

In some embodiments, the series of road segments is for a citywide system.

In some embodiments, the series of sensors includes at least a sensor in a traffic light and at least one standalone sensor adjacent the road segment.

In some embodiments, the tier road classification comprises a first tier of arterial roads that feed directly into pre-identified busy intersections, a second tier of feeder roads that feeds directly into the first tier of arterial roads and a third tier of local roads that feeds directly into the second tier of roads. In some embodiments, the tier road classification further comprises additional tiers of roads cascading outwardly to less busy roads and cascading to a city wide boundary.

In some embodiments, the vehicle information includes a size and type of vehicle, wherein the processor is configured to calculate a number of vehicles that can potentially fit on the road segment to determine a geometric maximum and further calculates the current vehicle count on the road segment to determine a vehicle fullness of the road segment. In some embodiments, synchronized capacity threshold scans are performed at first time intervals and synchronized capacity threshold scans are performed at second time intervals to thereby provide the system with real time updates of road traffic conditions. In some embodiments, the processor is configured to assign a value to a calculated capacity percentage, and when the value is determined to be above a preset value, feeder roads receive additional green light time.

In some embodiments, adjustment of traffic lights is based on road capacity determination and vehicle wait time on the road segment. In some embodiments, if the vehicle wait time exceeds a preset value, traffic light changes are initiated.

In some embodiments, the processor is configured to calculate vehicle volume change at synchronized cycle scans to assess traffic flow, wherein at intersections, a validation is performed to assess the difference in a sum of incoming segment outflow rates and a sum of outgoing segment inflow rates. In some embodiments, the processor is configured to conduct an operational performance validation to assess the accuracy of real time calculated outcomes with predicted outcomes. In some embodiments, the processor conducts strategic performance validations at intervals of at least one month to determine if the system is working on a network scale.

In some embodiments, the processor is configured to display on the geospatial grid the road segment capacity states on a map based setting and updates traffic lights and intersection adaptive timing schedules in accordance with calculations. In some embodiments, in response to a performance validation, the system self learns and adjusts to provide more accurate predictive inputs for subsequent traffic light adjustments.

In some embodiments, the processor is configured to determine if a subset of a set of green lights can be extended for a period of time.

In some embodiments, the processor is configured to calculate simultaneously a vehicle capacity on the road segment and assesses how far congestion propagates from a hot zone to detect how congestion cascades through a network hierarchy.

In accordance with another aspect of the present invention, a smart traffic management system is provided comprising a first sensor positioned in a first traffic light to detect vehicle information, a second sensor remote from the first sensor and positioned adjacent a road segment, the second sensor transmitting data to one or both of the first sensor remote processor, and the first sensor transmitting data to one or both of the second sensor or remote processor. The processor is configured to store data received from the first and second sensor, process the data to detect current vehicle traffic status of road segments of a geospatial grid representative of multiple road segments cascading from high capacity road segments to lower capacity road segments, conduct real time capacity scans of the road segments, visually display real time road segment capacity and create traffic signal setup based on road segment capacity.

In some embodiments, the processor is configured to conduct an operational performance validation to assess the accuracy of real time calculated outcomes with predicted outcomes.

In some embodiments, the processor is configured to calculate simultaneously a vehicle capacity on the road segment and assesses how far congestion propagates from a hot zone to detect how congestion cascades through a network hierarchy.

In accordance with another aspect of the present invention, a method for controlling traffic lights to improve traffic flow is provided comprising a) receiving vehicle information of vehicle size and number on a plurality of road segments from a plurality of sensors monitoring the road segments; b) determining traffic status on the road segments by comparison of the real time vehicle information to pre-calculated vehicle capacity of the road segments; c) creating traffic signal setup based on the traffic status; d) conducting updates either continuous or at preset intervals of vehicle capacity on the road segments; e) assessing vehicle capacity on road segments feeding into other road segments; f) updating the traffic signals in response to steps d and e.

The present invention in some aspects provides a computing device including a processor and a network interface coupled to the processor to enable communication over a network wherein the processor performs the calculations, predictions and validation functions disclosed herein.

In some embodiments, the present invention provides a non-transitory computer readable storage medium tangibly embodying a computer readable program code having computer readable instructions that, when executed, causes a computing device to carry out a method of generating a traffic light control/management system in accordance with the features, steps and components described herein.

In some embodiments, the present invention provides a computer program product embodying instructions to implement a traffic signal management system including program instructions to interpret data received from sensors, program instructions to determine a road segment tier classification and calculate road capacity on the road segments, program instructions to validate road status determinations and road status predictions and program instructions to adjust traffic signals based on the foregoing calculations/evaluations. The program instructions can include one or more of the detailed assessments, evaluations, calculations, adaptations, etc. described herein.

In some embodiments, the present invention provides a computer system for adapting traffic signal timing comprising a computer processor, a computer readable storage media and program instructions stored on computer readable storage media for execution of one or more processors wherein the program instructions interpret data received from sensors, determine a road segment tier classification, calculate road capacity on the road segments, conduct synchronized validation of road status determinations and road status predictions and adjust traffic signals based on the calculations/evaluations. The program instructions can include one or more of the detailed assessments, evaluations, calculations, adaptations, etc. described herein.

### BRIEF DESCRIPTION OF THE DRAWINGS

So that those having ordinary skill in the art to which the subject invention appertains will more readily understand how to make and use the system and devices/components disclosed herein, preferred embodiments thereof will be described in detail hereinbelow with reference to the drawings, wherein:

FIG. 1 is a diagram providing an overview of an embodiment of the smart traffic management system of the present invention, reflecting in general the hardware and software components;

FIG. 2 is a front schematic view of an embodiment of a smart traffic light of the smart traffic management system of the present invention showing an array of sensors;

FIG. 3 is a diagram showing schematically various sensors that can be provided in the traffic light of FIG. 1, the depicted sensors shown are in accordance with one embodiment of the sensing technology of the smart traffic management system of the present invention;

FIG. 4 is a more detailed diagram of the smart traffic light of FIG. 1 in accordance with an embodiment of the smart traffic management system of the present invention;

FIG. 5 is a diagram showing the components of the smart traffic management system of the present invention, and the communication/interaction of the components, in accordance with one embodiment;

FIG. 6 is a flow diagram of the data flow of the smart traffic management system of the software component of the present invention in accordance with an embodiment;

FIG. 7 is a flow diagram of the traffic signal coordination system of the real time traffic optimization subsystem of the smart traffic management system of the present invention;

FIG. 8 is a flow diagram of the system architecture for the real time traffic optimization;

FIG. 9 is a representation of the five layers of the system architecture of FIG. 8 with their associated functions;

FIG. 10 is a diagram showing an example a grid of the roads, the hot zones intersections and capacity after the assessment and calculations performed by the system of the present invention.

### DETAILED DESCRIPTION OF PREFERRED EMBODIMENTS

The present invention provides a smart traffic management system designed to assess traffic/congestion conditions, evaluate the conditions and provide steps to alleviate such traffic/congestion conditions. This is achieved via sensing technology preferably provided in a series of traffic lights working in conjunction with strategically placed remote sensors connected to a network to transmit the collected data. The data is transmitted to a cloud based platform through a wireless communication, such as cellular, Wi-Fi, Bluetooth, etc., where it is processed and analyzed by the unique software and algorithms of the present invention, and thereafter sent to traffic management systems for adjustment of traffic light signals and, in some embodiments, messaging visible to vehicle drivers (and pedestrians) and in more advanced systems sent directly to the traffic lights without intervening human manipulation. In some embodiments, mobile applications integrated with the system can inform individual drivers of traffic conditions.

The system can be used to assess road conditions on a large scale, encompassing a large number of roads, and in fact has the capability of assessing road conditions and adapting/controlling traffic signals in a citywide basis. Thus, in some embodiments, the system of the present invention can provide traffic control for an entire city, or at least the main roads and feeder roads feeding the main roads. This is achieved by the sensors and system architecture described below.

The system of the present invention, in short, provide a processor that receives data from the various sensors, evaluates the data via a geospatial grid, continuously updates its evaluation via real time continuous data transmission from the system sensors, and displays road segment capacity to enable traffic signal setup and control. To get from data input to accurate traffic control, the system detects vehicle numbers and sizes, assigns ratings/scales to different roads dependent on typical use, compares current vehicle capacity with pre-calculated vehicle capacity, and assesses waiting timing of vehicles on road segments. Further, the system conducts synchronized operation scans, conducts validation assessment for objective measurement of system performance and has predictive capabilities for future traffic scenarios. Still further, the system uses self learning to analyze traffic patterns and improve performance. Each of these features/aspects are discussed in detail below.

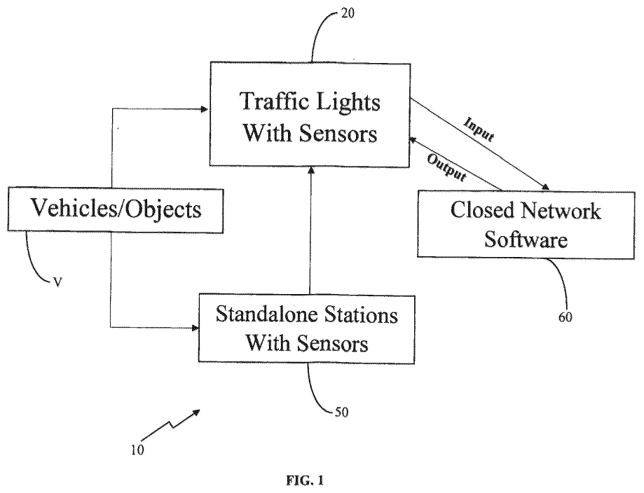

Turning first to the overall system of the present invention, and with reference to the overall system diagrammatically depicted in FIG. 1, the system, designated generally by reference numeral 10, includes a series of traffic lights 20 (also referred to herein as traffic lights L) with sensors, a series of remote sensor stations 50 with sensors (referred to herein as standalone sensors) and closed network software 60. The standalone sensors sense various conditions/parameters from the vehicles/objects V as described below and transmit the data to the traffic lights 20. (In addition, or alternatively, although not shown in the arrows of FIG. 1, the standalone sensors can transmit the data to the closed network software 60). The traffic lights 20 via their internal sensors sense various conditions as described herein. The data from the traffic light sensors and remote sensors are evaluated/processed and transmitted/inputted to the closed network software. After the processing by the software and algorithms described in detail below, instructions are transmitted/outputted to the various traffic lights to effect traffic light patterns (traffic signal patterns) and in some embodiments to transmit messages to the occupants of vehicles V and pedestrians. Data is also stored in the various computing devices as described below. Thus, the smart traffic lights 20, standalone sensors 40, and closed network software 50 all act in unison to address traffic and congestion. Recognizing that traffic generally originates from one or multiple points of entry which feed into a pinpointed location (e.g., busy road or intersection) in what is observed as traffic/congestion, the smart traffic management system of the present invention advantageously addresses this.

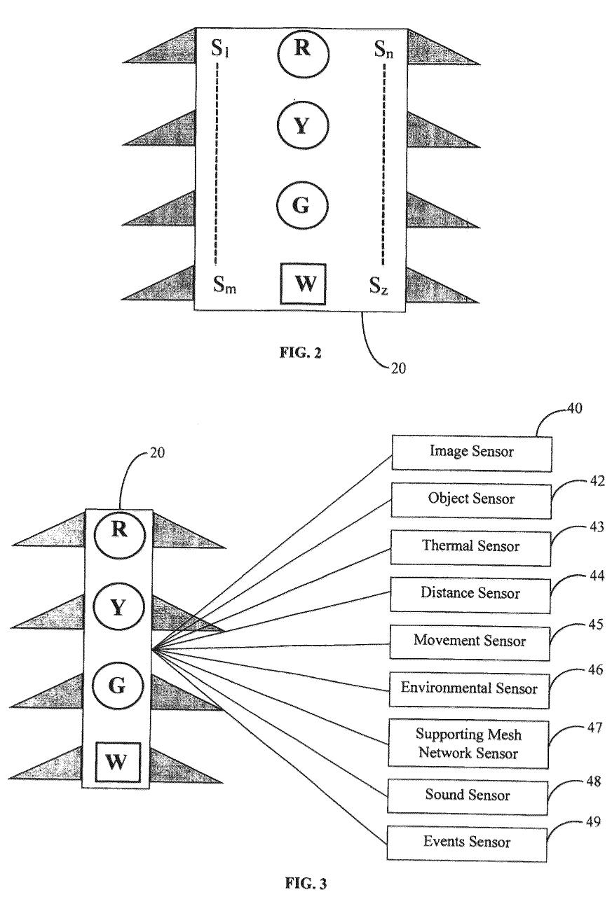

Turning initially to the core hardware components of the system 10, and with reference to FIG. 2, an embodiment of one of the series of traffic lights 20 is illustrated. The traffic light 20 includes four color light LED modules♯ the three traditional colored modules which are red-yellow-green (designated “R” “Y” and “G” respectively) plus a fourth white module W. The fourth module W is a text box designed to provide concise messages to pedestrians and drivers that are in proximity to the traffic light 20. An example of a message that may be generated and shown on the fourth module can be, “Six inches of snow expected. Drive Slowly!” Information on accidents or events that can affect traffic flow can also be conveyed in the text box. Note the text box W is shown schematically and in preferred embodiments is larger than that shown and preferably larger than the other LED modules to provide sufficient space for conveying messages in large enough text to be easily read by pedestrians and drivers. As can be appreciated, the system 10 includes a series of smart traffic lights similar to traffic light 20, the number depending on its application, e.g., a small neighborhood vs a city. It should be appreciated that alternate embodiments of the system omit the fourth module W in conducting the traffic control/management described herein.

The smart traffic light 20 also includes a range of sensors to extract vehicle and in some embodiments environmental information. FIG. 3 shows examples of some sensors that can be utilized. It should be appreciated that the sensors listed are provided by way of example and additional sensors can be provided. It should also be appreciated that fewer sensors than those listed can also be provided in some embodiments as long as they are sufficient to enable the function of the smart traffic management system 10 of the present invention. The traffic light sensors can include image sensor 40, object sensor 42, thermal sensor 43, distance sensor 44, movement sensor 45, environmental sensor 46, supporting mesh network sensor 47, sound sensor 48 and events sensor 49.

More specifically, the sensors can include for example a) a Lidar sensor (Light Detection and Ranging) for objects and distance sensing via laser beam emission to provide a highly accurate 3D mapping of a given location to help precisely measure vehicle speed and positioning; b) a thermal/infrared sensor to detect objects, e.g., vehicles and pedestrians, based on heat signatures (advantageous at night or adverse weather conditions); c) mmWave Radar to detect and track objects via high frequency radio waves; d) an inductive sensor for detecting vehicles via sensing changes in inductance due to metallic objects presence; e) one or more environmental sensors to detect conditions such as weather radar, air quality, etc.; e) a [local] social media and events sensor; f) an image sensor such as a high resolution camera; g) a supporting mesh network sensor providing a decentralized communication system for data collected by one or more of the traffic light sensors; h) sensors to detect sounds such as city sounds of large events, emergency vehicles, traffic noise, etc.; and/or i) sensors compatible with smart cars and infrastructure.

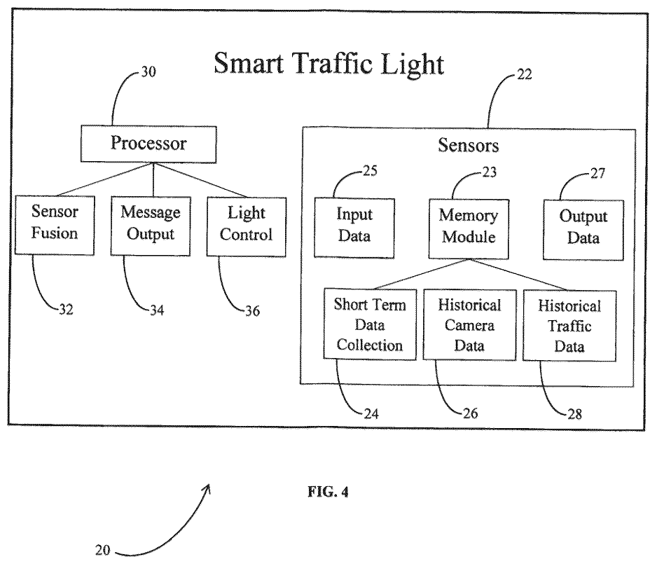

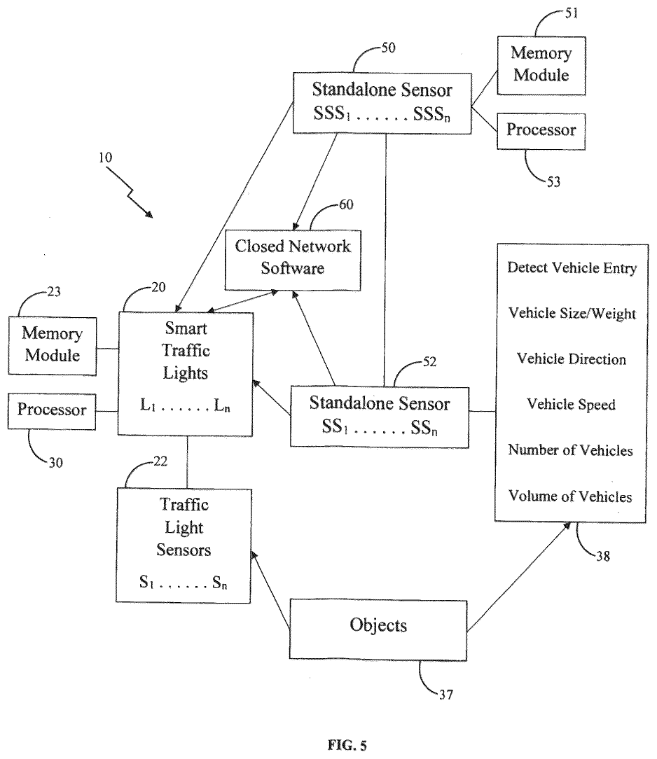

The smart traffic lights 20 also have a built-in processing unit 30 that is capable of performing the act of sensor fusion 32 for short term data collection. This is depicted in the diagram of FIG. 4 which also illustrates the processor 30, after sensed data computation and evaluation, controlling message output 34 and light 36 of the traffic light 20. The sensor 22 of the traffic light 20 has a memory unit/memory module 23 for storage of short term data 24 and a limited amount of historical camera data 26 or traffic data 28 that is compatible with the traffic light computing unit.

The sensors 22 receive the data (data input 25) from the external objects, environment, etc. and transmit the data (output data 27) to the processor 30 within the traffic light 20. The sensor fusion 32 collects, processes and combines data from the various traffic light sensors 22 (as well as from the stand alone sensors 52), resolving inconsistencies and minimizing errors caused by individual sensor limitations, thereby reducing uncertainty of the information. The data is transmitted/accessible to the network software which provides light control 36 as described below. The processor 30, based on the sensed data of the traffic light sensors 22 and standalone sensors 52, can in some embodiments, provide some message output 34 to the white box W, or alternatively or in addition, can work in conjunction with software which controls the messaging in the message output 34. As noted above, in some embodiments, the messaging in Box W can be omitted from the system.

The sensors 22 in some embodiments are symmetrically lined in a vertical row on both sides of the four color light LED modules shown in the diagram of FIG. 1 and illustrated schematically as sensors S₁ to Sₙ on one side of the LED modules and Sₙ to Sₘ on the other side. Other arrangements/arrays of sensors within the traffic light 20 are also contemplated.

The traffic lights 20 are preferably housed in a weather proof/weather resistant housing unit to protect internal components. Note the processing unit is stored in a secured location within the traffic light as a preventive/cautionary measure.

The standalone sensors 50 are remote from the traffic lights 20, but in wireless communication with one or more of the traffic lights 20. The standalone sensors 52 (also referred to as standalone sensors SS) are provided in standalone sensor stations 50 (see FIG. 5) strategically placed such as at the critical entropy points for key detection purposes. The entropy points can include for example intersections, roundabouts, merge points, pedestrian crossings, work zones, etc. The standalone sensor stations 50 (also referred to as standalone sensor stations SSS) can be formed of weather proof/weather resistant materials.

The sensors 52 are responsible for doing two things: 1) passing along key data and decisions to and/or from other computing devices of the smart traffic management system; and 2) detecting the entrance of vehicles that enter into proximity of the system. The detection preferably includes one or more of: 1) vehicle size/weight; 2) vehicle direction; 3) vehicle speed; 4) number of vehicles; and 5) volume of vehicles (See block 38 of FIG. 5). These sensors 52 may further include a) inductive loop detectors for sensing changes in inductance cause by the presence of the vehicles as they pass over or stop at the loop; and/or b) mesh network sensors for communication which are wirelessly interconnected and work together to collect, share and transmit data. Other sensors are also contemplated as are fewer sensors. The sensors 52 can communicate with standalone sensors 52 in other standalone stations 50 and/or with the traffic light sensors 22. They can also communicate with the network software via wireless connection thereto or via the traffic light processor (CPU) 30 for transmission of data. The standalone sensor stations 50 can include a memory module 51 for storing data and a processor 53 enabling data processing and data transmission.

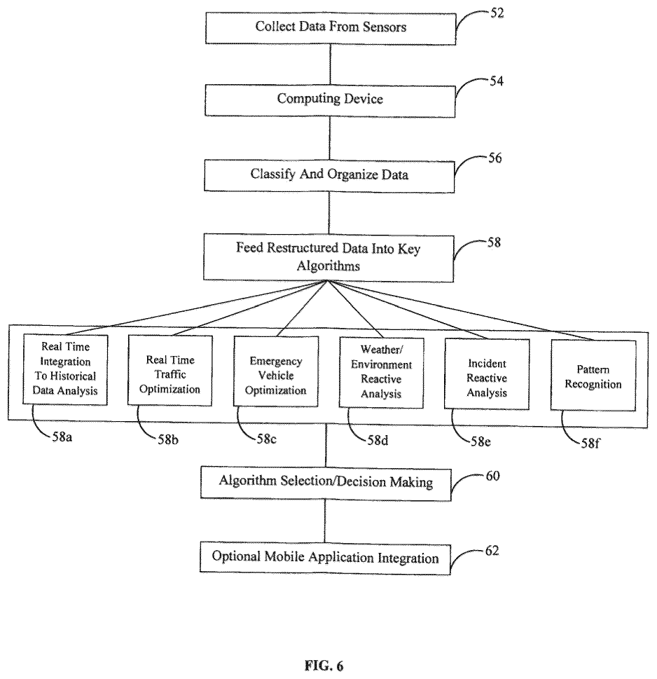

Turning now to the software of the traffic management system of the present invention and with reference to the flow diagram of FIG. 6, the data flow will now be discussed. The data flow 50 has the following steps 52-60, and optionally the additional step 62.

In the first step 52 (data collection), the data is collected from the various traffic light sensors 22 and standalone sensors 52 which will be able to provide a wide variety of data points to the other computing devices of the system 10. In preferred embodiments, data collection occurs in real time and the system is capable of detecting, speed, direction, size of the vehicle (which can be depicted by the shape of the vehicle), weight of the vehicle, number of vehicles, temperature, weather conditions, volume of cars sitting in a pinpointed location (e.g., intersection), and other desired data. The data collected can be understood by reference to FIG. 4 depicting various traffic light sensors 22 and FIG. 5 depicting various standalone sensors 52, and also discussed in detail above. It is also envisioned that the standalone sensors 52 can also include one or more of the sensors 22 of FIG. 3 to complement/supplement or substitute the traffic light sensors 52 of FIG. 3 and that the traffic light sensors 22 can include one or more of the standalone sensors 52 of FIG. 5 to complement/supplement or substitute the standalone sensors 52 of FIG. 5. It should also be appreciated that although real time data collection is preferable, it is also envisioned that near real time or delayed collection, e.g., at short predetermined intervals, or delayed transmission from the sensors, is also contemplated.

In the second step 54 (data processing), the raw data is then communicated by the use of the mesh sensors to the next computing devices within the system which are located in the traffic lights 20 and optionally in the standalone sensor stations. Provision of the multiple mesh network long range sensors enables packaging of the collected data points into efficient packets and transmitting that data in regular (predetermined) intervals of time to the next computing device in the system. In some embodiments, the data can be transmitted in under 5 seconds per interval, although longer or shorter transmission intervals are also contemplated. Alternatively, the data transmission can be at irregular intervals, determined by traffic conditions, weather conditions, time of day, etc. Such intervals can be preset or automatically adjusted based on preset parameters, threshold ranges, etc., and the use of AI can inform such adjustments. The objective of the data processing is to pass on key data points and metrics to other parts of the traffic management system 10 but also to the cloud based software 60 (FIG. 1) for higher level computing and analysis.

With continued reference to FIG. 6, in the third step 56 (data analysis), the computing devices which are located within the smart traffic lights 20 and in some embodiments, also located in the standalone sensor stations 50 housing the standalone sensors 52, will first classify and organize the data to fit and be compatible with the system's software. This will allow the real time data to be analyzed accordingly for real time decision making to occur as described below.

In the fourth step 58, the restructured data is fed into the smart system's key algorithms to actively learn about the newly detected information and to provide options that can be effectuated by the entire traffic management system. The System's AI unit will be facilitating this process. The algorithms that can be built into the processing components and the system's core software can be as follows, although not limited to the following:
a) Real time integration to historical data analysis 58a which provides the ability to review historical video data, should it be available in a desired location. This allows the system to learn potential short term and long term traffic patterns and trends of a desired location which will assist in real time traffic light decision making. Such historical data is not limited to video data but can include other conditions detected by one or more of the sensors.
b) Real time traffic optimization 58b—a default algorithm which utilizes the data points collected and the smart system then decides on the most efficient way to alleviate short term build up of traffic.
c) Emergency vehicle optimization 58c to detect emergency vehicles such as ambulances, firetrucks, and a fleet of police vehicles and provide a streak of green lights clearing their path for emergency vehicles to get through. This will also in some embodiments prompt the fourth module of the traffic lights 20 to provide text relative to this situation such as, “Allow Emerg. Vehicles To Pass” or other alert messages. The system will also trigger other smart traffic lights 20 to turn red until the emergency vehicles have passed through accordingly. Detection of passage of the emergency vehicles so the system can return the traffic lights 20 to the “pre-emergency” pattern can be a result of imaging/video, audible detection, e.g., a lack of sound emitted from ambulances or fire trucks over a certain time frame, etc.
d) Weather/environment reactive analysis 58d enables the smart system to adjust accordingly to significant weather and local environment effects. Common examples are heavy snow storms and local sporting events. The system will be useful in communicating these events to local drivers and pedestrians to alert them to navigate cautiously and accordingly. For instance, due to the cameras (e.g., Lidar) which can supplement the weather sensor, the system has an even more accurate and comprehensive view of the roads subject to the current real time weather conditions. This helps guide the system to adjust the traffic lights and flow of traffic in a more precise manner. Thus, the system enables real time adjustment based on collection and processing of real time data. In addition, in a preemptive or anticipatory usage, the system is also designed to recognize the scheduling and impact of local sporting and entertainment events in advance. The specific algorithm is triggered when a local significant event is scheduled to take place and the system will preemptively plan to alleviate traffic accordingly.
e) Incident reactive analysis 58e enables the system, when vehicle accidents or incidents from its sensors are detected, to prioritize clearing the pathway leading up to the accident and incident for emergency vehicles to arrive. The system will also adjust the smart traffic lights 20 accordingly to target the potential build up of cars that may materialize following a traffic accident.
f) Wide range or large scale pattern recognition 58f, guided by the cloud based software system, will detect and adjust the smart traffic lights 20 accordingly to significant traffic events. It will work uniformly across multiple intersections. This will combat traffic grid locks and cascading traffic events.

The algorithm can in some embodiments also include recognition and accommodation for system malfunction. Such fail safe protocol accounts for damage to the system. With this protocol, should a smart traffic light be damaged, then the system will still be able to operate in the following order, depending on the extent of damage:
i) Partial sensor degradation and traffic light processor is still intact—if some sensors are malfunctioning, the system can still operate based on all the working components and sensors;
ii) Significant sensor loss and traffic light processor is still intact—the system will be guided by its historical patterns and trends to make decisions applicable to that specific time of year, month, day, hour so the decisions are well intentioned in terms of managing traffic;
iii) The processing unit is completely inoperable—then the traffic light will revert to a developed time based temporary plan until the traffic light processor is replaced and is up and running again.

As can be appreciated, the algorithms explained above can all be utilized in the traffic management system 10 of the present invention. However, it is also contemplated that not all, e.g., fewer than the six (s-f) listed above, of the algorithms be utilized and would still provide advantages over current systems. It is also contemplated that additional algorithms can be utilized to effect additional functions of the system 10.

With continued reference to FIG. 6, in the fifth step 60 system (decision making), those who are authorized to manipulate traffic lights will have a number of options to choose from in order to manipulate traffic appropriately. They will also be able to manually indicate which algorithm should go into effect. It is also contemplated that the decision making step can in alternate embodiments be automatically controlled without user intervention. In this instance, AI can be used to inform such decisions. Machine learning can help process the data and provide improved parameters and inputs to enhance use of the technology in manual as well as machine manipulation.

It is also contemplated that in some embodiments, mobile application integration can be provided. This optional step 62 is depicted in FIG. 6. The mobile application can supplement the entire system. Users of the application would be able to digest traffic data points in their proximity, and in some embodiments/versions, to all integrated towns and cities of the traffic management system 10. The mobile app can provide its own navigation and will be able to depict the volume of traffic. The app is also designed to show drivers which integrated neighborhoods have low/medium/high levels of traffic which is represented by color (e.g., green, yellow, red).

With reference to FIG. 5, the overall system 10 of the present invention will be described. As shown, there are a series of traffic lights 20, designated by L₁ . . . Lₙ, each of the traffic lights 20 having a memory module 23 short and optionally long term data storage and processor/computing device 30 for data assessment, organization, transmission, etc. Contained within each of the traffic lights 20 are traffic light sensors 22, designated by S₁ . . . Sₙ, the sensors described above and shown for example in FIG. 2. L₁ . . . Lₙ and S₁ . . . Sₙ are utilized for brevity so as to encompass multiple lights and sensors in the FIG. 5 diagram, the number of lights will depend on the particular application/use of the system and the number and type of sensors can vary as described above. A series of standalone sensor stations, designated by SSS₁ . . . SSSₙ, are provided as part of the hardware of the system. Each standalone sensor station SSS includes a plurality of sensors 52, designated by SS₁ . . . SSₙ, such as those depicted in FIG. 5 and described above. SSS₁ . . . SSSₙ and SS₁ . . . SSₙ are utilized for brevity so as to encompass multiple sensor stations and sensors in the FIG. 5 diagram, the number of stations will depend on the particular application/use of the system and the number and type of sensors can vary as described above.

The processor 30 within the smart traffic light processes the data as described above. The standalone sensors 52 can also communicate with the smart traffic lights 20 so data transmitted by sensors 52 are processed by processor 30 as described above. In some embodiments, the data from the standalone sensors 52 is transmitted only to the smart traffic lights 20 for computing, organizing, etc.; in other embodiments the smart traffic lights are bypassed and the software receives data transmission from the traffic lights 20 and standalone sensor stations 52 independently, wherein it is then collated, processed, classified, etc. as described above; in still other embodiments, the data is transmitted from the standalone sensor stations SSS to both the traffic lights 20 and software 60. This latter embodiment is depicted in FIG. 5 by the arrows indicating transmission/flow. In any of these three scenarios, the inputted data is received as described herein and processed via the various algorithms described herein. The standalone sensor stations 50 can also include a processor 54 and a memory module 56 that can provide short term storage of data and optionally long term storage of data.

In general terms in reference to FIG. 5, objects 37 such as vehicles or pedestrians, and various features of the vehicles and pedestrians, are detected by the traffic light sensors 22 and the standalone sensors 52, along with other external conditions, and the data sent to the traffic light processor 30 and standalone sensor station processor 56, if provided. The closed network software receives the data from the sensors 52, 56 and processes the data in accordance with the dataflow of FIG. 5. The number and positioning of the sensor stations is optimized to achieve the traffic management objectives of the present invention.

As can be appreciated from the detailed discussion above, the smart traffic management system of the present invention provides a wide variety of algorithms which are fed by the data sourced from the traffic light and standalone sensors and historical data (if available) to ultimately go much further than providing instantaneous updates to traffic conditions and pinpointed speeds. It delivers preemptive plans of actions to alleviate traffic, on a short term more immediate time frame, to a large city wide scale, and from cascading traffic effects should they arise. Furthermore, the software is integrated to the traffic lights so effectuates the key adjustments to traffic patterns and conditions that should arise. The system advantageously uses sensors at various locations to accumulate the data instead of relying on unpredictable or inconsistent data from cars or phones.

Unlike some other current systems which focus on learning traffic patterns from multiple video data surveillance cameras, the sensors and systems of the present invention do not solely rely on surveillance cameras for their analysis. The system 10 can, for example, use optical sensors, radar sensors, environmental sensors, and/or inductive sensors to capture moving vehicles and pedestrians that navigate the roadways. Thus, in preferred embodiments, it uses a combination of different sensors to provide a comprehensive view of a targeted location.

The system of the present invention is intended for guiding traffic patterns, and although not specifically intended to be a tool for law enforcement, there are benefits for law enforcement and can in some embodiments be utilized as such tool.

The memory described herein can include for example a Random Access Memory (RAM), including SRAM or Dynamic RAM (DRAM), Read only memory (ROM),); volatile memory, non-volatile memory, etc.

Although described above as functioning as a closed network, an open network is also contemplated.

A multi-channel system is also envisioned. In short, one channel would be used for communication on a small scale/local level, while, simultaneously, another channel would be used for communication on a larger scale, e.g., a city-wide scale.

It is also contemplated that in some embodiments specific programs to filter and refine the data to make the system processing more reliable can be provided. In short, the overview of the progression of traffic management is as follows: traffic management—smart traffic management advanced traffic management—and automated traffic management. Components and programs designed for filtering and refining the data and processes would make the system more reliable and help advance the entire system forward in such progression of traffic management.

Additionally, with the advent of EVTOL vehicles (Electric Vertical Take-Off and Landing) and flying cars, the system of the present invention can be designed to include the ability to track and incorporate these types of vehicles and their impact on traffic flow and congestion. For example, a hybrid of an air to land traffic management system can be provided. Additional cameras and sensors can be utilized to track and monitor such vehicles.

The computational methods that implement the real-time traffic optimization algorithm (element 58b, FIG. 6) which articulates the traffic signal control optimization systems capacity state road segment analyses, tier based network organization, synchronized operational scans, and self-learning validation and refinement through performance metrics ATSPM will now be described in detail.

In short, the traffic signal coordination system manages traffic by synchronized operational scans that allow it to exercise its predictive capabilities for proactive coordination. Additionally, the system is designed to self-learn, validate its own processes and calculations, and adjust traffic signals accordingly.

Computational principles have been combined to create an adaptive traffic signal coordination system that analyzes real-time traffic flow to make proactive signal adjustments and forecast future traffic scenarios for predictive traffic management.

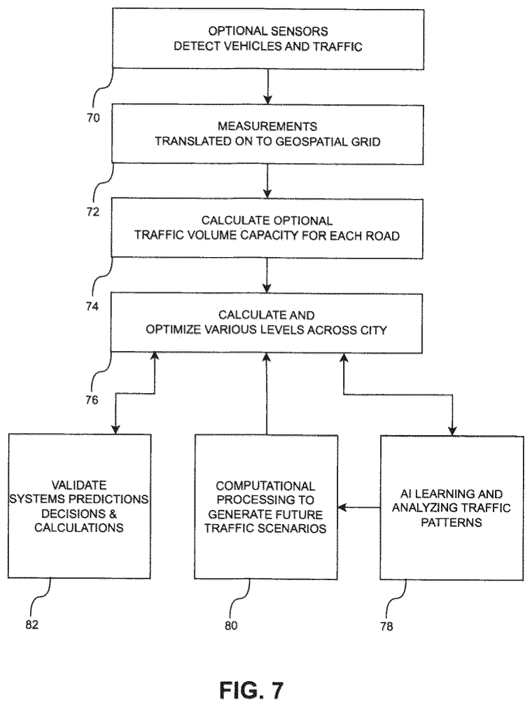

The system of the present invention when used on a city-wide scale uses a geospatial grid of a given city that is configured with the system's geometric and physical constraints. At the outset, it should be appreciated that although described below for use on a city-wide scale, the system can be used for other larger or smaller sized areas; e.g., town, region, etc. With reference to the flow diagram of FIG. 7, which summarizes the overall system, optical sensors (e.g., smart cameras) as described above are connected to the system and are strategically positioned at intersections (and other locations) to detect vehicles and traffic volumes 70 and the measurements are translated into precise positions on the geospatial grid 72. This is made possible by coordinated transformation matrices (a computing software technique) that convert real-world traffic detection into digital coordinates on the grid or similar computing processes and techniques. From there, the system calculates the optimal traffic volume capacity for each road within a given city 74 to maximize balance in terms of traffic management across the entire city. Once this is available, the system calculates and optimizes the various traffic levels across the city 76 through its smart traffic signal coordination system.

The system heightens its intelligence by learning and analyzing unique traffic patterns over time 78. Fast computational processing in real time enables predictive capabilities that generate future traffic scenarios 80, which can be used to influence proactive traffic signal coordination decisions and strategies.

As the system strives for objectivity in traffic management, it takes its analysis and data processing a step further—it sets up and calculates baseline traffic performance metrics across the city through a performance measurement (ATSPM) layer to validate the system's predictions, decisions, and calculations against actual traffic outcomes (see block 82). In return, the system learns, recalibrates, and adjusts its traffic signal optimization engine to function as close as possible to the truth of a city's actual traffic health, parameters, and capacities.

In a nutshell, the system is designed to identify and have an understanding of all the different road segments in a city which is necessary for city-wide traffic balancing. To achieve this, it creates for organizational purposes a road tier classification for organizing all main roads that connect to and make up busy intersections as Tier 1 roads, and then classifies the roads that feed into these main roads as arterial roads, or Tier 2. Sequentially, the roads that connect all the way out to the boundary or edge of a city are consistently grouped by lower tiers—Tier 3, Tier 4 and so on and so forth.

There are in general three components of the system: geospatial grid/platform+cloud based software+traffic sensors.

The system's architecture consists of five integrated layers that form a complete closed-loop control system for the system's operation:
Layer 1—Geometric Design
Layer 2—Vehicle Detection and Capacity Conversion
Layer 3—Baseline Throughput and Capacity Threshold Targets
Layer 4—ATSPM (Percutaneous) Validation System
Layer 5—Traffic Signal Optimization and Execution

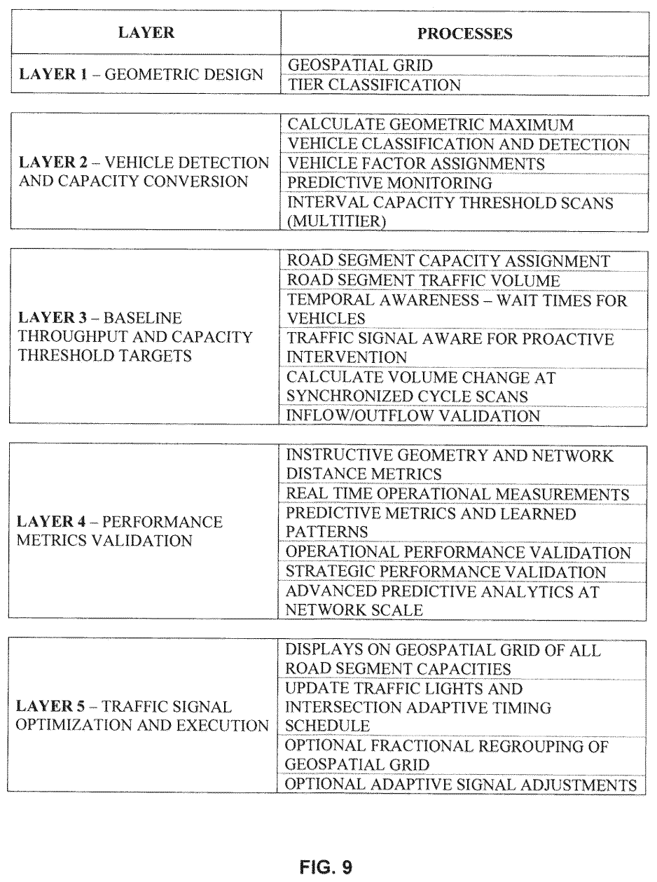

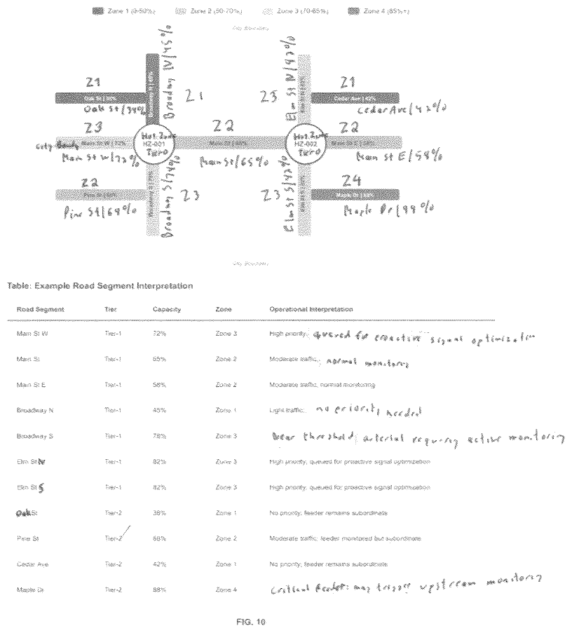

FIG. 9 provides a Table to give an overview of each Layer, with a more detailed description of each Layer and its components/subsystems provided below. With Reference to FIG. 9, in summary, Layer 1 provides road segment tier classification and capacity and distance evaluations/calculations of the road segments; Layer 2 provides geometric maximum calculations of the road segments, predetermined interval scans of the road segments and vehicle classification. Layer 3 provides evaluation/calculation of road segment capacities and traffic volume, wait times for vehicles, traffic signal status and real time road segment volume change calculations; Layer 4 provides real time operational measurements, predictive analytics and performance validation; and Layer 5 provides displays of road segment capacities and traffic light control optimization.

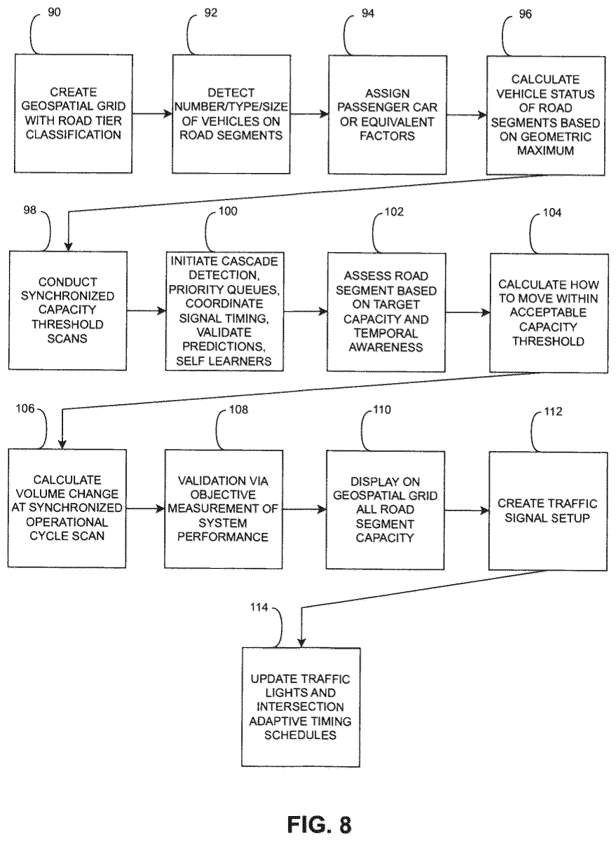

Prior to the discussion of the Layers in more detail, an overview of the System will be explained in reference to the flow diagram of FIG. 8. The implementation of these features/processes will be further understood from the detailed discussion of the individual Layers below. With reference to FIG. 8, the system processor operates/functions/is configured to create a geospatial grid with road tier classification 90, detects number and type/size of the vehicles on the road segments 92, assigns passenger car or equivalent factors 94 (for proper geometric spacing); calculates vehicle status of road segments based on geometric maximum 96, conducts synchronized capacity threshold scans 98, initiates cascade detection, priority queues, coordinates signal timing, validates prediction and self learns 100, assesses road segments based on target capacity and temporal awareness 102, utilizing the geospatial grid calculates how to move within acceptable capacity threshold 104, calculates volume change at synchronized operational cycle scan 106, validates via objective measurement of system performance 108, displays on the geospatial grid all road segment capacity 110, creates a traffic signal setup 112 and updates lights and intersection adaptive timing schedules 114.

The individual Layers performing the above steps will now be discussed in detail.

### Layer 1

In Layer 1, Geometric Design, the geospatial grid functions as the foundational setting of the traffic signal coordination/optimization system. It understands vehicle traffic behavior and provides the digital replica of a city that is effectively populated by the readings provided by the optical sensor.

The Geometric component establishes the mathematical boundaries, physical constraints, and network relationships that define what is possible within the road network. It provides the foundational parameters that subsequent calculations, vehicle observations and analyses need to respect, particularly the geometric maximum capacity for each road segment and the quantified distances that govern how traffic changes propagate through the network.

Note the system described herein has sufficient tools, metrics, subsystems, etc. that enable its use on a city-wide basis, to control traffic flow on a series of roads or road segments that can be used for monitoring traffic for an entire city. Thus, the Layers and metrics below are described in terms of a city layout. However, as noted above, it should be appreciated that the systems described herein can be used on a larger scale or smaller scale such as monitoring or controlling traffic in certain areas/regions of a city, town, etc.

To implement the geospatial grid, an AI-powered map analysis is used to scan, review and calculate a given city's map for digitizing and accessibility within the geospatial grid. Computer vision and artificial intelligence analyze city maps from OpenStreetMap data (or equivalent map data sources), satellite imagery, and GIS files to automatically configure the system. The AI system identifies road types, lane counts, intersection sizes, and hot zones based on physical infrastructure analysis. It recognizes geometric features including the number of streets, actual primary routes, exits and entrances into the city, and hot or primary locations.

The geospatial grid serves as the spatial framework for capacity state tracking. Each road segment is recognized on the geospatial grid by its unique identifier for system reference, precise GPS coordinates establishing its geographic location, geometric capacity calculated from lane count and physical dimensions, hot zone classification which identify the busiest intersections among a grouping of road segments and serve as focal points for network coordination. The database structure inherently implements directional separation for all road segments by storing each physical road as multiple logical segments.

Hot zones represent the geographically largest intersections with the highest geometric capacity—these are objectively measurable based on physical characteristics like lane count, intersection size and observed traffic volumes. As specified in the arterial-feeder balance philosophy, hot zones serve as the anchor points or base for the tier-based cascade system, with all other roads classified by how they feed into these critical network locations.

The geospatial grid reflects each road segment connections to intersections and actual geographical path, and geometric configuration. The roads are indexed by tiers for organizational traffic reduction priorities.

A base to the tier classification for road segments are the hot zones, defined as geographically the largest intersections. The tier classification ranks road segments in the following in descending order:
1. Tier-0: Hot Zone Intersections—busiest intersections, highest capacity
2. Tier-1: Arterial roads—roads that feed directly into busy intersections or hot zones
3. Tier-2: Feeder roads—roads that feed directly into Tier-1 roads
4. Tier-3: Local roads—roads that feed directly into Tier 2-roads
5. Tier-N: Continue cascading outward until city boundaries or capacity thresholds detected

This hierarchical structure of Tier 1 . . . Tier N enables the system to coordinate traffic flow ensuring that decisions at one tier level account for their impact on the tiers above. The number of Tiers will vary dependent on the area being analyzed where largest areas such as a city would typically be classified/represented with more tiers than for example a smaller town.

### Layer 2

Turning to Layer 2, Vehicle Detection and Capacity Conversion, this component bridges the gap between physical vehicle presence and abstract capacity state representation. It detects actual vehicles on road segments using the smart sensor technology described above and converts these detections into capacity percentage measurements that the network rules can process. The system preferably uses optical sensors with AI-integrated cameras for vehicle classification and detection or other types of sensors such as those described above.

These smart sensors provide several capabilities beyond simple vehicle counting. The AI-powered computer vision performs real-time vehicle type identification, distinguishing between cars, trucks, buses, motorcycles, and bicycles. This classification enables accurate PCE (Passenger Car Equivalent) factor assignment. For example, the classification can be designed so that trucks count as 2.0 passenger car equivalents due to their length and acceleration characteristics, buses as 2.5 equivalents, and motorcycles as 0.5 equivalents. Other designations/counts are also contemplated to achieve the vehicle size differentiation for road capacity analysis. These Passenger Car Equivalent assignments can also, in some embodiments, have additional variability to account for different size trucks and buses detected by the sensors and cameras of the system. In summary, the smart sensors count cars and other vehicles, taking into account size and thus space occupying differences, which are important for indexing and conversion purposes as it relates to the systems analysis of the progression of traffic flow that is observed.

Before the system starts operating, a capacity percentage threshold conversion is conducted which calculates the theoretical maximum number of vehicles that could physically fit on each road segment if they were packed bumper-to-bumper with safe following distances. This “geometric maximum” is based on simple geometry: the road segment's length in meters, divided by average vehicle length (6 meters), multiplied by the number of lanes, multiplied by a density factor that accounts for safe spacing. The system divides the current PCE-adjusted vehicle count by the geometric maximum capacity. This produces a decimal value between 0.0 and 1.0, which is then multiplied by 100 to create a percentage. For example, a segment with 30 vehicles present out of a maximum capacity of 100 vehicles equals 30% capacity. This percentage tells the system exactly how full the road segment is at this moment. As can be appreciated by this formulation, a greater number of vehicles for a given maximum capacity will yield a higher percentage; a smaller number of vehicles for a given maximum capacity will yield a lower percentage. Similarly, a given number of vehicles for a larger maximum capacity will yield a lower percentage than a given number of vehicles for a smaller maximum capacity.

This proportional conversion maintains mathematical consistency throughout as the capacity percentages reflect actual physical occupancy relative to geometric constraints.

The proportional conversion accounts for stopped vehicles at red lights versus moving vehicles on green, adjusting capacity calculations based on signal states. During red phases, the system measures queue length and growth rate; during green phases, it measures departure rates and queue dissipation speed.

The system performs synchronized capacity threshold scans in preselected cadences/time intervals to provide continuous monitoring. The cadences can be unified for all tiers or alternatively in multiple tiers, with each tier providing a different time interval. By way of example, in some embodiments, the scans for the road segments can be on the following cadences: 1) every 5-10 seconds; 2) every 30-60 seconds; 3) every 5-10 minutes. Other cadences/intervals are also contemplated. Additionally, cadences/intervals can in some embodiments be different depending on the road tier assignment, e.g., longer intervals on less traveled tiers, i.e., tiers further out from the hot zones.

The system operates through a multi-tier synchronized scanning architecture that performs multiple integrated functions simultaneously. In an example of a three-tier system, at the first Operational Tier (e.g., 5-10 seconds adaptive), the system i) collects fresh capacity measurements across all road segments, ii) initiates hot zone cascade detection that reverberates through the network hierarchy, iii) builds intervention priority queues based on arterial-feeder balance requirements, iv) executes signal timing adjustments through traffic controllers, and v) validates predictions against ground truth measurements from sensors. This is continuous predictive monitoring, not reactive response—the system doesn't wait for congestion to happen but continuously monitors, predicts, and adjusts.

At the second Strategic Tier (e.g., 30-60 seconds), the system i) validates network-wide capacity distribution predictions across 3-12 operational cycles, ii) assesses aggregate system performance against city-specific baseline throughput targets, and iii) coordinates signal timing across zones of influence defined by network distance metrics.

At the third Learning Tier (e.g., 5-10 minutes), the system i) aggregates all predictions made during the window, ii) calculates composite accuracy scores across all timing tiers, iii) identifies systematic biases in prediction algorithms, and iv) refines calibration parameters to continuously improve performance.

As can be appreciated, these scanning intervals and cycles are provided by way of example as other scanning intervals and cycles are also contemplated.

### Layer 3

Turning now to Layer 3, the Baseline Throughput and Capacity Threshold Targets, this layer establishes what optimal traffic flow should look like for a specific city by providing the target capacity state distribution throughout a city that the system pursues to maintain. The core logic to this traffic signal coordination system is that each and every road segment in a given city is to be measured (as calculated in Layer 2) and assessed under the following capacity of traffic volume readings or zones per road segment:
1. No Priority (0-50% capacity of road segment)—normal operations, arterials maintain full priority
2. Low Priority (50-70% capacity of road segment)—moderate conditions, system monitors feeder roads
3. High Priority (70-85% capacity of road segment)—feeder roads receive increased green time, proactive intervention begins
4. Highest Priority (>85% capacity of road segment)—emergency intervention required

The premise is a road segment is to maintain approximately 75% of vehicles for its size to initiate a priority light change, but once it reaches 75% and above it automatically enters itself into the traffic signal queue order. With this type of orientation, an adaptive traffic signal coordination system has the capabilities of achieving city wide heavy traffic volume balancing.

But at the same time, the system has temporal awareness and takes into consideration the wait times for cars at all road segments, and this is where the system's understanding of the road segment, as indexed by the tier system, becomes beneficial. By assessing a road segment's combination of real time traffic volume and wait time at a red light, the system develops a real framework of priority and hierarchy among all road segments which allows it to manage capacity thresholds on a city-wide level. Thus, the system via its algorithms balances road capacity and wait times as shown below.

Maximum acceptable wait times integrated with capacity thresholds:

### Zone 1 (0-50% Capacity)—Stable/No Action

No wait time trigger
Arterial maintains full priority
Rationale: Low capacity=no urgency—vehicles flow freely with minimal intervention
   Zone 2 (50-70% capacity) OR Wait≥90 s—Monitor
90 seconds
Begin monitoring and preparing intervention as vehicles begin interacting but flow remains smooth
Rationale: Below psychological breaking point (80 second limit found in some studies), but signals attention needed
   Zone 3 (70-85% capacity) OR Wait≥60 s—Active intervention
60 seconds
Active intervention required due to high density approaching instability
Rationale: approaching threshold
   Zone 4 (>85% capacity) OR Wait≥45 s
45 seconds
Emergency intervention due to critical congestion and spillback risk impact
Rationale: prevents breakdown at unstable flow levels

### Absolute Override: 240 Seconds (Unchanged)

Rationale: Threshold exceeded

As can be appreciated, the above percentages are utilized by the system to maximize traffic flow, however, it should be appreciated that other capacity percentages or other time intervals (number of seconds) can be utilized in the system algorithms to adapt to different scenarios or to adapt the system based on self learning during use, evaluation and real time validation of the system.

Once traffic is represented as capacity percentages, the geospatial grid and processing engine calculates how to systematically move the network toward baseline throughput targets to stay below or within acceptable capacity threshold limits for given segments. The system also takes historical data and recordings into consideration in its analysis. This provides mathematical optimization toward targets.

Furthermore, the system recognizes that active traffic signals (i.e., red or green) create deterministic boundary conditions for traffic flow. When a downstream signal displays red, outflow from the upstream segment drops to zero as vehicles cannot proceed through the intersection, causing volume to accumulate on the segment. When the signal changes to green, outflow increases to the segment's discharge capacity rate as the queue releases through the intersection. This signal-aware logic provides predictive power because signal timing is known in advance—the system doesn't need to predict when signals will change, it knows when they will change because it controls them.

The following metric, Capacity Trajectory Projection, illustrates this. This metric evaluates what will the capacity be 10-60 seconds in the future. This enables proactive intervention before thresholds are exceeded. This is like a “crystal ball”. Instead of waiting for a road to HIT 75% full, the system predicts “this road WILL BE 75% full in 30 seconds if we don't do something now.” It's like weather forecasting for traffic—it sees the storm coming and adjusts signals before the backup happens.

It starts from NCSS (measurements of road segment capacity states) and projects future NCSS. Thus, this trajectory projection uses current NCSS C_i(t) as the initial condition and calculates future NCSS values:
Input: C_i(t) from current NCSS as starting point (C=capacity; i=segment; t=time)
Transformation: Apply flow dynamics+signal timing+network topology
Output: Predicted_C_i(t+Δt)=future NCSS value

Later, when it reaches t+Δt, it compares Predicted_C_i(t+Δt) against Actual_C_i(t+Δt) measured by NCSS to score prediction accuracy.

With continued reference to the third Layer (Baseline Throughput and Capacity Threshold Targets), the Core Volume Wave Intelligence system calculates volume change at synchronized operational cycle scan (i.e., 5-10 seconds) by subtracting previous measurement from current measurement for each road segment. Positive change indicates growth with traffic accumulating on the segment; negative change indicates shrinkage with traffic clearing from the segment. Near-zero change indicates stable flow through the segment. These wave patterns reveal traffic dynamics across the network, showing where congestion is building, where roads are clearing, and where flow is steady. At each intersection, the system validates that vehicles entering must exit somewhere or remain in storage. The validation i) sums all incoming segment outflow rates, ii) sums all outgoing segment inflow rates, iii) calculates conservation error as the difference between inflow and outflow, and iv) flags errors exceeding five percent (or other predetermined percentage) as potential sensor malfunctions. This validation serves as quality assurance for the sensor network, catching camera miscounts, broken inductive loops, or calibration drift before bad data affects traffic control decisions.

### Layer 4

Turning to Layer 4, the Performance Metrics integration (ATSPM) Layer, unlike traditional traffic management systems, this system is designed to uncover the objective levels and truth of a city's traffic health by continuously recording and updating a multitude of traffic metrics. It sets up and calculates baseline traffic performance measurement (ATSPM) to validate the system's predictions, decisions, and calculations against actual traffic outcomes. This validation framework provides comprehensive, objective measurement of system performance and serves dual purposes: proving system effectiveness through objective performance measurement and enabling continuous learning through systematic parameter refinement. For instance, when prediction accuracy falls below established thresholds, the system automatically adjusts discharge rates, signal modifiers, and turning movement percentages to improve future predictions. This constitutes the self-learning component of the system.

There are six Data Metric and Calculation Categories:
Category 1: Infrastructure & Network Foundation (Calculated once, static)
Category 2: Real-Time Operational Measurements (Every 5-10 Seconds)
Category 3: Decision Support & Predictive Metrics (Used for Control Decisions)
Category 4: Performance Validation—Operational (10-Minute Evaluation Cycles)
Category 5: Performance Validation—Strategic (Quarterly Evaluation)
Category 6: Advanced Predictive Analytics (Future-Oriented Capabilities)

In Category 1, there are several metrics, all calculated during system setup, rarely adjusted or updated and define structural foundation. These can be subdivided into 1) Infrastructure Geometry and 2) Network Distance.

### 1. Infrastructure Geometry

a) Geometric Maximum Capacity for calculating road capacity—calculates the maximum number of vehicles that can physically fit on a road segment, based purely on geometry (road length×number of lanes×spacing). This informs “how many cars can physically fit on this road segment if they were parked bumper-to-bumper (with safe spacing).” It's the maximum possible, based on geometry alone. A longer road with more lanes can hold more cars. This Geometric Maximum is the denominator in the NCSS calculation: NCSS capacity=Vehicles Present/Geometric Maximum. (vehicles present in calculated utility PCE Passenger Car Equality (PCE)). Note the NCSS provides a primary foundation measurement as the other metrics reference NCSS.

The NCSS runs a calculation of all the capacity states for all the road segments in a given city, in a real time synchronized basis (e.g., 5-10 seconds) in accordance with the Tiers 1 . . . N discussed above. It is the synchronized measurement of capacity states for all road segments in the network, organized hierarchically and in preferred embodiments executed at three time scales (although other timing intervals are also contemplated):
Operational Tier (5-10 seconds): Fresh ground truth for immediate decisions
Strategic Tier (30-60 seconds): Network-wide validation against baseline targets
Learning Tier (10 minutes): Prediction accuracy scoring and parameter refinement

NCSS also has a hierarchal structure—it does not treat all segments equally as. measurements are executed in cascade priority order:
1. Tier-0: Hot Zone Intersections (FIRST)—Busiest intersections, highest capacity
2. Tier-1: Arterials (SECOND)—Main roads feeding hot zones, target≤70% capacity
3. Tier-2: Feeders (THIRD)—Side streets feeding arterials, target≤75% capacity, 240 s max wait
4. Tier-3+: Local Roads (FOURTH+)—Continue cascading to city boundaries

An example of this is provided below:

For each segment i at time t:

Step 1: Convert vehicle detections to Passenger Car Equivalents (PCE)

Vehicle_Count_PCE(i,t) = Σ[Vehicle_j × PCE_Factor_j]
where PCE_Factor = {1.0 cars, 2.0 trucks, 2.5 buses, 0.5 motorcycles}

Step 2: Retrieve geometric maximum capacity for segment

Geometric_Maximum(i) = (Segment_Length / 6 meters) × Number_of_Lanes ×
Density_Factor

Step 3: Calculate capacity state (this is NCSS)

C_i(t) = Vehicle_Count_PCE(i,t) / Geometric_Maximum(i)

Step 4: Bound to valid range

C_i(t) = min(max(C_i(t), 0.0), 1.0)

Output: C_i(t) = capacity state [0.0 to 1.0] for segment i at time t

NCSS is like taking a photograph of every street in your city at the exact same moment—measuring how full each road is (0%=empty, 100%=completely full). This happens, in preferred embodiments, every 5-10 seconds. Other features of the system start from these synchronized snapshots.
b) Hot Zone Identification—identifies which intersections are the geographically largest, highest capacity, naturally handle the highest volumes that serve as focal points for network management. The hot zones are the biggest, busiest intersections, like the downtown main intersection where the most roads come together and the most cars pass through daily. These are the VIP intersections that get checked first because if they get jammed, the whole city backs up. Hot zones are Tier 0 in the NCSS hierarchy, and their values are measured first in every synchronized snapshot.
c) Tier Classification—identifies which hierarchical tier (0, 1, 2, 3 . . . N) each road segment belongs to, defining its priority in the cascade system and baseline capacity targets. Each tier has different rules, i.e., more strict with main roads, e.g., keeping them at 70% capacity) and giving side streets a bit more wiggle room, e.g., 75% capacity, but guaranteeing no one waits too long, e.g., more than 4 minutes.
   2. Network Distance—quantifies network connectivity and defines how traffic changes propagate through the road network. They are calculated during system setup and updated only when network topology changes. The include the following six metrics.
a) Effective distance—how easily do traffic changes propagate between two road segments, accounting for physical distance, travel time, capacity constraints, and signal coordination? This measures realistic connectivity rather than simple geographic proximity. Physical distance doesn't tell the whole story. Two intersections 400 meters apart might be “effectively” 660 meters apart if traffic moves slowly between them, capacity is high, or signals aren't coordinated. Consider it like walking distance vs. driving distance in a city—sometimes nearby places take longer to reach. This metric measures how “far apart” intersections really are in terms of how traffic changes spread between them.
b) Network diameter—what is the maximum effective distance between any two intersections in the system? This defines the largest coordination challenge and determines whether network-wide optimization is feasible or if the city must be partitioned into coordination zones. This measures how “big” the city's traffic network is, not in miles, but in how far traffic changes can travel. If, for example, network diameter is 5,200 meters effective, that means the farthest two intersections are “effectively” 5.2 km apart in terms of how traffic propagates. This informs whether it can coordinate the whole city at once (small diameter) or need to break it into zones (large diameter). Network diameter aggregates effective distances which themselves derive from historical NCSS measurements. It represents the maximum resistance to NCSS propagation across the entire network.
c) Zone of influence—for each intersection, it determines which other intersections fall within coordination distance and require synchronized timing decisions. This defines the local coordination zone where signal adjustments must be considered together. Each intersection has a “neighborhood” of other intersections that it needs to coordinate with so when signals are adjusted the system needs to consider how it affects others. But it doesn't need to worry about intersections outside the zone because they're too far away to be affected. This simplifies coordination from “coordinate all x intersections” to “coordinate these specific “y” (fewer than “x”) intersections.” Zone of influence is calculated during system setup using NCSS capacity change correlations to validate which intersections truly influence each other. For example, two intersections within distance threshold but showing Correlation<0.25 indicates they don't actually affect each other's capacity states despite proximity.
d) Propagation Reach—determines how far will a signal timing change's effects propagate through the network within specific time windows. This determines which roads need real-time coordination, strategic coordination, or can operate independently. It considers: when a traffic signal is changed, how far does that change “ripple” through the network? For example, in 10 seconds, it might only reach 50 meters (the next intersection); in 60 seconds, it could reach 300 meters (3 intersections away); in 20 minutes, effects can spread across 6 kilometers affecting 15 intersections. This informs which intersections need instant coordination (e.g., within 10 seconds) versus which ones which can be handled more slowly (e.g., within a minute or 20 minutes). Propagation reach is derived entirely from observing how NCSS capacity changes propagate through the network over time. The system measures time and speed.
e) Cascade depth—it determines for each hot zone, the maximum number of tier levels that could contribute traffic, and how deep can congestion cascade upstream before reaching segments with consistently low capacity. This defines operational boundaries for hot zone cascade management.

When a big intersection (hot zone) gets congested, cascade depth informs how far back the traffic jam spreads. If an intersection is, for example, at 78% capacity, the system checks: Are the main roads feeding it also congested? Are the side streets feeding those main roads congested? Are the small local streets feeding those side streets congested? So, if for example the cascade is 3 tiers deep—the system needs to fix problems at 23 intersections, not just the original hot zone. Cascade depth is calculated by analyzing current NCSS capacity measurements across the hierarchical tier structure. The system traces C_s(t) values from Tier-0 (hot zone) through Tier-1, Tier-2, Tier-3, etc., until finding a tier where congestion rate drops below 20% (or other predetermined percentage).
f) Arterial coupling strength—determines how strongly do two parallel arterial roads influence each other. This measures whether changes to one arterial road significantly affect the parallel arterial (high coupling) or whether they can be optimized independently (low coupling). That is, when two big roads run parallel to each other, are they independent or connected? By way of example, if two parallel roads are only 300 meters apart with 8 cross streets connecting them, they're VERY coupled—when one street gets congested, drivers use the cross streets to shift to the other parallel street. And assuming historical data shows 23% of traffic shifts between them. This means it can't just optimize one street alone; the system needs to consider both roads together because they affect each other.

As explained above, the Geometric Maximum Network capacity state snapshot (NCSS) determines the maximum number of vehicles that can physically fit on a road segment, based purely on geometry (length×lanes×spacing). NCSS is the system's foundational perception layer. Instead of tracking individual vehicles, it measures how full each road is. This macroscopic approach scales efficiently, remains stable under congestion, and serves as the reference state for predictions, interventions, and validation steps.

Thus, the Network Distance metrics identify upstream contributors and predicts downstream capacity, predicting what vehicles will arrive before they arrive, enabling proactive congestion prevention and preventing spillback—induced gridlock by stopping vehicles before they enter already—saturated downstream links—overriding normal signal plans when necessary.

In Category 2 of Layer 4, there are several metrics, all measured/updated in real-time operational loops, utilizing raw sensor data. These Real-Time Operational Measurements are preferably performed every 5-10 seconds based on live sensor data and form the core operational data flow. The metrics in this category include:
a) Current capacity percentage (NCSS)—assesses how full each road segment is RIGHT NOW, expressed as a percentage (0%=empty, 100%=completely full). This is the NCSS measurement. This number forms a basis for the system. It answers: “How full is this road right now?” If a road can hold 100 cars max and currently has 60 cars, it's 60% full. This is measured for every road segment, preferably every 5-10 seconds, preferably all at the same time (synchronized). This is the Network Capacity State Snapshot. Everything else either derives from it, validates against it, or aggregates it.
b) Capacity Zone Classification—assesses which of the four capacity zones each road segment is currently in (Zone 1/2/3/4), which determines urgency level and wait time tolerances. Road fullness is divided into four zones: Zone 1=plenty of room (0-45%). Zone 2=getting busier (50-70%). Zone 3=getting tight (70-85%). Zone 4=critical, nearly full (over 85%). The fuller the road, the shorter the system lets it wait for a green light. A nearly empty road can wait two minutes. A nearly full road only waits 60 seconds max. This metric takes the raw NCSS capacity value Ci(t) and classifies it into discrete zones. It's a categorical transformation of the continuous NCSS measurement.
c) Wait time accumulation—determines how long (in seconds) a road segment has been waiting since its last green phase ended. This is the factor for fairness guarantees. Like a stopwatch, when a light turns red, counting starts. If any road waits more than 4 minutes, it is given a green light. Wait time is measured independently of NCSS but they work together in decision making.
d) Signal phase state—assesses the current state of the traffic signal (RED/GREEN/YELLOW) and when the next phase change is scheduled. This is deterministic knowledge critical for trajectory prediction. Is the light red, green, or yellow RIGHT NOW? How long until it changes? During red, cars pile up (accumulation mode=0.5 multiplier). During green, cars leave (discharge mode=1.5 multiplier). Knowing the signal state enables prediction of what capacity will be in the next 30-60 seconds. Signal state determines how the NCSS value will evolve. During RED, C_i(t) increases (cars accumulate). During GREEN, C_i(t) decreases (cars discharge). This deterministic knowledge enables accurate short-term NCSS trajectory projection.
e) Inflow rate—assesses how many vehicles per second are entering a road segment from upstream segments, accounting for turning movements and discharge rates. How many cars are flowing into this road from the roads behind it? For example, if one street is 62.5% full with a green light, and 75% of those cars turn onto another street, the system can calculate exactly how many vehicles per second are entering that Street. This enables prediction if it is about to get fuller. Inflow calculation requires C_j(t) NCSS measurements from all upstream segments j that feed into segment i.
f) Outflow rate—assesses how many vehicles per second are leaving a road segment, based on current capacity and signal state. How many cars per second are leaving this road? During green, cars leave fast (e.g., ~0.15 per second per lane). During red, only a trickle leave (e.g., ~0.02 per second) as the queue slowly crawls forward or clears the intersection after yellow. Outflow calculation uses C_i(t) NCSS measurement for segment i to determine how many vehicles are available to discharge.

Thus, Category 2 of Layer 4 reads current capacity from NCSS utilizing Zone 1-4 classification of aforedescribed Layer 3, computes inflow and outflow rates, adjusts net flow based on upcoming signal phase, projects forward at seconds and Δt. Consequently, it provides control—instead of reacting after congestion occurs, the system predicts where capacity is heading and intervenes early, preventing instability before it forms.

In Category 3 of Layer 4, there are several metrics which directly support or generate signal timing decisions, combining learned patterns with forward projection and real-time predictions. All feed into the optimization algorithm that determines actual signal timing. These Decision Support & Predictive Metrics are used for control decisions and can be subdivided into three categories: 1) Predictive Calculations comprising a) Capacity Trajectory Projection (predicts capacity changes 10-60 seconds ahead), b) Discharge Rate (measures flow behavior for arrival predictions) and iii) Arrival Time Prediction (predicts downstream arrivals for offset optimization); and 2) Learned Patterns comprising a) Turning Movement Percentages (historical turning behavior) and b) Natural Traffic Load Patterns (time-of-day demand patterns); and 3) Decision Outputs comprising a) Priority Level Determination (signal priority assignment) and b) Arterial Can-Yield Determination (arterial-feeder balance decisions).

### 1. Predictive Calculations

a) Capacity Trajectory Projection—predicts capacity changes 10-60 seconds ahead—what will the capacity be 10-60 seconds in the future? This enables proactive intervention before thresholds are exceeded. Instead of waiting for a road to HIT 75% full, it predicts “this road WILL BE 75% full in 30 seconds if something is not done now.” It's like weather forecasting for traffic—seeing the storm coming and adjusting signals before the backup happens.
b) Discharge rate—measures flow behavior or arrival prediction—how quickly does traffic capacity discharge through a road segment during green phases, measured as the percentage of geometric capacity clearing per second. When a light turns green, how fast does the queue of cars clear out? For example, if a street starts at 68% full and drops to 32% full during a 40-second green light, the system knows it's discharging at about 0.9% of capacity per second. This informs how quickly traffic flows through this segment, which is needed to predict when cars will arrive at the next intersection. This metric transforms NCSS from a static snapshot (“how full is this road?”) into a dynamic flow measurement (“how fast is traffic clearing?”). The NCSS measurements taken every 5-10 seconds during green phases provide the raw data; this metric extracts the discharge behavior pattern that enables predictive offset optimization.
c) Arrival time prediction—predicts downstream arrivals for offset optimization—when will vehicles currently occupying segment i effectively arrive at and proceed through downstream intersection j, accounting for startup delays, physical travel time, and downstream signal coordination. This enables synchronized green wave timing along arterial corridors. For example, if vehicles on street A Street will reach Street B in 67 seconds, the system checks Street B's signal schedule. If Street B will be red when they arrive, the system knows they'll have to wait. The system calculates this total time (travel+waiting) and recommends adjusting Street B's green start time to match Street A's platoon arrival, creating a green wave where drivers cruise through consecutive green lights without stopping. Metrics are learned from historical observations and refined over time through the learning cycle. Thus, NCSS is transformed from passive measurement into active coordination intelligence, using capacity state snapshots to predict and synchronize traffic flow across the network.

### 2. Learned Patterns

a) Turning movement percentages—evaluates historical turning behavior. What percentage of vehicles go straight/left/right at each intersection? This varies by time of day and is learned from historical patterns. Not all cars go straight. Some turn. This metric learns the pattern. For example, during morning rush, 75% of cars from Street A go straight onto Street B, 15% turn left, 10% turn right. This is learned by watching for e.g., 10 minutes, then used to predict where cars will go for the next several hours (until traffic patterns change). By observing how NCSS values change at connected segments over time, the system can infer turning movements. If Street A NCSS drops by 15 vehicles while Street B NCSS rises by 12, we know ~80% went to Street B. These learned percentages become Transfer Fractions in the Inflow calculation, which determines how upstream NCSS measurements affect downstream NCSS predictions.
b) Natural Traffic Load patterns—evaluates time of day demand patterns—typical traffic volumes and capacity states by time of day and day of week, establishing baseline expectations against which to detect anomalies. The system learns “normal.” After watching traffic for weeks, for example, it knows “Street A is usually 50-60% full on Monday mornings at 8 AM.” If it suddenly sees 80% on a Monday morning at 8 AM, it knows something weird is happening—maybe an accident, maybe a special event. This helps identify problems quickly. This metric is essentially the statistical summary of thousands of past NCSS measurements, organized by time and context. Real-time NCSS measurements are compared against learned patterns to detect anomalies: Is Current_NCSS_Normal=f(Current NCSS, Historical NCSS patterns).

### 3. Decision Inputs

a) Priority level determination—signal priority assignment—what priority level (0/1/2/3) should a feeder road receive for signal timing allocation, balancing capacity state with wait time. This decides “how badly does this side street need a green light RIGHT NOW?” It's like a triage system. Not urgent (Level 0)=low capacity, short wait. Somewhat urgent (Level 1)=medium capacity or longer wait. Very urgent (Level 2)=high capacity and long wait. EMERGENCY (Level 3)=critical capacity OR waited more than 4 minutes. The more urgent, the more green time you get. This metric integrates NCSS capacity measurement Cf(t) with wait time context to determine urgency. NCSS capacity ALONE isn't enough. For example, a 60% full road that's been waiting 250 seconds is more urgent than an 80% full road that just got a green light 10 seconds ago.
b) Arterial Can-Yield Determination—determines signal priority assignment—can an arterial road afford to give up green time to help a feeder, or is the arterial road too congested to yield? This asks: “Can the main road give up some green time to help the side street, or is the main road too busy?” For example, if Street A is at 60% capacity (below the 70% target), it has room to spare. But if Street A is at 75% or the big intersection it feeds is backed up, Street A needs to keep its green time-arterial priority maintained. This metric requires NCSS measurements from both Tier-1 (arterial) and Tier-0 (hot zone) to make a network-aware decision. This demonstrates NCSS cascade logic: decisions about Tier-2 feeders depend on NCSS states of both Tier-1 arterials and Tier-0 hot zones.

In Category 4 of Layer 4, there are several metrics which preferably operate on 10-minute evaluation cycles, feed learning loops and validate operational performance. These Performance Validation-Operational metrics, can be subdivided into two categories: 1) Traditional ATSPM Validation comprising a) Split Failure Detection, b) Phase Termination Analysis, c) Arrivals on Green, d) Platoon Ratio, e) Approach Delay, and f) Effective Green Bandwidth (Validates green wave coordination quality; and 2) Custom Self-Learning Validation comprising a) Capacity State Prediction Accuracy, b) Capacity Threshold Philosophy Validation and c) Intersection Influence and Cascade Effects. In short, these metrics provide operational performance validations of the various computations, calculations, assessments, road prioritizations, traffic light coordination, correlations of vehicle outflow/inflow with traffic light status, cascade effects, and fairness guarantees (vehicle wait time) of the multi-tier roads managed and controlled by the system of the present invention (see Layer 4 of FIG. 9). This helps to ensure optimized functioning, i.e. optimized traffic management, of the system.

### 1. Traditional ATSPM Validation

a) Split Failure Detection—was the green light long enough to clear the waiting vehicles? A split failure means green time was insufficient (“the green light wasn't long enough.”) It is detected by checking: For example, was the road over 80% full during the ENTIRE green phase? Is it STILL over 80% full 5 seconds after it turned red? If yes to both, the green light failed to clear the backup—it should have been longer. Split failure detection uses NCSS capacity measurements at specific time points (during green, during first 5s red) to assess signal timing adequacy. Input is Multiple C_i(t) NCSS measurements during phase cycle, Transformation is temporal aggregation (averages during green vs red) and Output is Boolean split failure flag+performance metrics. This is an ATSPM validation metric—it uses NCSS as ground truth to evaluate whether signal timing decisions were correct.
b) Phase Termination—how does each signal phase end—by gap out, max out, force off, or skip? This diagnostic informs if timing is adequate for demand. This informs WHY the light changed. Did it change because no more cars were coming (gap out=good)? Or because it ran out of time even though cars were still waiting (max out=need more green time)? Or because the coordinated system forced it to change to stay in sync (force off=normal for coordination)? The Phase termination analysis validates whether signal timing decisions (driven by NCSS capacity measurements and priority determinations) are providing adequate service. The validation logic is as follows:
NCSS shows C_f(t)>0.75→System increases green time→Phase Termination should show fewer max outs
If max outs persist despite NCSS-driven adjustments→Indicates timing or capacity threshold miscalibration

Note this is a validation metric that checks if NCSS-driven signal timing decisions achieve intended outcomes. These metrics execute continuously with predetermined evaluation cycles, e.g. 10 minute intervals, to validate system performance. Note this and metrics b-g are Validation metrics as they validate performance by comparing predicted outcomes based on NCSS-driven decisions against actual measured results.
c) Arrivals on Green—validates Arrival Time Prediction Metric (described above) for accuracy—what percentage of vehicles arrive at an intersection during the green phase? This validates coordination quality. It validates accuracy of the arrival time prediction metric which provides normal traffic observation, i.e., when will vehicles currently occupy the road segment effectively arrive at and proceed through downstream intersection, account for startup delays, physical travel time and downstream signal coordination. How many cars get a green light when they arrive? If 75% of cars arrive on green, that's excellent—they're flowing smoothly. If only 40% arrive on green, they're hitting red lights and stopping frequently. This tells us if the coordinated “green wave” is working. It validates Outcomes From NCSS-Driven Timing using NCSS measurements (Real Time Operation Measurements of Category 2 discussed above) to make signal timing decisions. It validates whether those timing decisions create effective coordination. The validation flow is as follows:
NCSS shows C_a(t)≤0.70 on Tier-1 arterial→System maintains arterial priority timing
Timing decisions establish offsets and coordination
Arrivals on Green measures actual vehicle arrival patterns
High Arterial on Green (AoG) % confirms NCSS-driven timing decisions are working Note this is a validation metric—it doesn't use NCSS directly, but validates that NCSS-driven decisions produce coordinated traffic flow.
d) Platoon Ratio—are vehicles arriving in coordinated groups (platoons) or randomly distributed? This distinguishes real coordination from coincidental timing. This checks if cars are arriving in groups (like a bunch arriving together) or spread out randomly. If there is good coordination, cars leave the upstream light together as a group and arrive as a group at the next light. A platoon ratio of 1.5 means vehicles are arriving 50% more concentrated during green than random timing would predict. It validates Coordination Quality from NCSS Decisions: While Arrivals on Green measures HOW MANY vehicles arrive on green, Platoon Ratio measures WHETHER they're arriving in organized groups. The Validation Logic is as follows:
NCSS-driven timing creates offset coordination
Good offsets should create platoon arrivals (ratio>1.1)
If AoG is high but Platoon Ratio≈1.0→Green time is generous but not truly coordinated
If both AoG and Platoon Ratio are high→Confirms NCSS-driven coordination is working

This validates that NCSS-driven timing decisions create actual traffic flow organization, not just lucky timing.
e) Approach Delay—how long do vehicles wait from when they join the queue until the signal turns green? This validates fairness guarantees. How long do cars wait at a red light? The system ensures for example no one waits more than 4 minutes (240 seconds). This metric measures actual wait times to ensure this occurs. If wait times are consistently high, the system knows it needs to give that approach more green time. It validates fairness from NCSS+Wait Time Decisions: combines NCSS (current capacity measurements) with Wait Time Accumulation to determine Priority Levels. Approach Delay validates whether those priority decisions deliver promised fairness. The validation chain is as follows:
NCSS shows C_f(t)>0.70 AND Wait_Time>120 s→Priority Level 2
System grants extended green time to feeder
Approach Delay MEASURES actual wait times
If delays remain >240 s→Indicates priority escalation isn't working

This validates that NCSS-driven+wait-time-driven priority decisions achieve fairness guarantees in practice.
f) Effective Green Bandwidth—how much usable green time do arterials actually receive after accounting for queue clearance and side street interference? This validates arterial priority effectiveness. How much of the promised green time does the main road actually get? If the side street runs long, the main road loses some of its green time. If the side street finishes early, the main road might get extra. This measures whether the arterial priority is working or if side streets are stealing too much time from the main roads. It measures overall green wave quality achieved through offset optimization. This Validates Arterial Priority (Arterial Can-Yield Determination of Category 3), validates whether this arterial—feeder balance preserves arterial priority. The validation flow is as follows:
NCSS shows C_a(t)≤0.70 on arterial→System maintains arterial priority
NCSS shows C_f(t)>0.75 on feeder→System grants additional feeder time
Effective Bandwidth measures if arterial still receives adequate green
Low bandwidth efficiency—Feeder service is degrading arterial progression

In short, it validates that NCSS-driven arterial-feeder balance decisions don't sacrifice arterial priority.

### 2. Custom Self Learning Validation

a) Capacity State Prediction Accuracy—how accurate are the capacity trajectory predictions? This drives the learning cycle that improves system intelligence over time. This is the report card. For example, it predicts “Street A will be 70% full in 30 seconds.” When 30 seconds pass, the actual NCSS measurement is checked: was it actually 70%, and if not, how far off was it. For example, if it's off by a small percentage, e.g., 2%, this indicates predictions are within the zone of accuracy. But if checking reveals it is consistently off for example by 5-10%, the system adjusts its math to be more accurate next time in its predictions. This is how the system learns and gets smarter. It validates predictions against actual NCSS. That is, it is the learning metric that compares predicted future NCSS values against actual measured NCSS values. It validates the metric accuracy which projects what the capacity will be in 10-60 seconds in the future, thereby enabling proactive intervention before thresholds are exceeded.
Input 1: Predicted_C_i(t+Δt) from Capacity Trajectory Projection (Category 3)
Input 2: Actual_C_i(t+Δt) measured by NCSS at future time
Transformation: Error calculation and pattern analysis
Output: Accuracy metrics+parameter adjustments

This closes the learning loop, with flow as follows: Predict future NCSS→Wait→Measure actual NCSS→Compare→Learn→Improve predictions.
a) Capacity Threshold Philosophy Validation—are the baseline throughput targets (e.g., 70% arterial, 75% feeder) being achieved system-wide? This validates the core capacity management philosophy. This metric asks the question: “Is the whole system philosophy working?” The system is trying to keep main roads at 70% or less, side streets at 75% or less, and nobody waiting more than 4 minutes. Every 10 minutes (or at other intervals), the system checks: Did it achieve these goals? If for example, 90% of roads met their targets, the system's accuracy is confirmed. If it's not close to 90%, the system figures out why and adjusts. It aggregates NCSS across all tiers: This metric uses historical NCSS measurements from both Tier-1 (arterials) and Tier-2 (feeders) to validate system-wide baseline achievement.
Input: All C_a(t) NCSS values for Tier-1 arterials (10-minute history)
Input: All C_f(t) NCSS values for Tier-2 feeders (10-minute history)
Transformation: Statistical aggregation and threshold validation
Output: Achievement rates and philosophy validation score

This is the metric that validates whether the baseline intentionality is working in practice.
c) Intersection Influence and Cascade Effects—how far upstream does congestion at a hot zone propagate? This validates the cascade depth concept and distance metrics. When the big intersection gets jammed, how far back does the traffic jam spread? This metric watches as congestion ripples upstream. If for example Street A and Street B are 80% full, the system checks: Is Street C (feeding it) also backing up? Is Street D (feeding Street C) also backing up? It assesses how many “layers” deep does the problem go. The deeper the cascade, the more aggressively the system will intervene upstream. It analyzes NCSS propagation patterns across tiers: uses NCSS measurements from all the tiers simultaneously to detect how congestion cascades through the network hierarchy.
Input: C_h(t) for Tier-0 hot zones (trigger condition)
Input: C_a(t) for Tier-1 arterials (first cascade level)
Input: C_f(t) for Tier-2 feeders (second cascade level)
Input: C_i(t) for Tier-3+ roads (deeper cascade levels)
Transformation: Spatial-temporal cascade pattern detection
Output: Cascade depth, propagation speed, influence zones

This metric demonstrates the full power of hierarchical NCSS: by measuring all tiers in synchronized snapshots, the system can detect how congestion flows through the network structure preferably.

In Category 5 of Layer 4, there are several metrics which provide long-term strategic assessment, preferably on a quarterly update frequency (although other intervals are also contemplated). Compared to Category 4 Operational Performance Validation providing assessments at frequent cycles, e.g., 10 minute cycles, Strategic Performance Validation metrics provide network-level assessment with less frequent evaluation. These include 1) Wang Attainability Index, 2) Khattak Planning Time Index, and 3) Dunn Speed Slowdown Ranking.
a) Wang Attainability Index (Tier 2 ATSPM)—How close does actual coordination performance come to the theoretical maximum possible given geometric constraints? This provides single-value network-wide scoring. Given the physical layout of the intersections (how far apart they are, what the speed limits are), it determines what's the BEST coordination that could possibly be achieved. This metric tells what percentage of that perfect ideal is actually getting. If for example, it's hitting 80% of the theoretical best, that could be satisfactory since there's only so much that can be done with the roads as they are. It provides a network-level validation of NCSS-driven coordination: While individual metrics validate approach-level performance, Attainability Index validates whether the entire NCSS-driven hot zone cascade coordination achieves near-optimal network performance. It is validation at network scale:
NCSS drives Tier-1 arterial coordination (70% capacity targets)
NCSS drives Tier-2 feeder coordination (75% capacity targets)
NCSS drives offset and timing decisions across network
Attainability Index measures if network-wide coordination approaches geometric limits High attainability (e.g., >80%) confirms the hierarchical NCSS-driven coordination strategy is working at network scale, not just at individual intersections.
b) Khattak Planning Time Index (Tier 2 ATSPM)—how much extra time must travelers budget to ensure 95% reliable on-time arrival? This measures travel time reliability and validates fairness philosophy. If someone needs to be somewhere on time 95% of the time, how much extra time would they need to leave? For example, if the drive normally takes 10 minutes, but the Planning Time Index is 1.8, 18 minutes should be budgeted to be safe. Low indices mean predictable travel times—the system's fairness guarantees (max 240-second wait) should keep this index low. It validates consistency from NCSS-driven fairness, designed to limit worst-case delays and improve reliability.

### Reliability Validation:

NCSS+Wait Time→Priority Level Determination (Category 3)
Priority decisions→x-second maximum guarantee (e.g., 240 second)
Maximum guarantee→Should limit extreme delays
Planning Time Index measures if worst-case travel times are bounded

Low PTI (e.g., <1.5) confirms that NCSS-driven fairness guarantees deliver predictable travel times, not just acceptable averages.
c) Dunn Speed Slowdown Ranking—which corridors have the most severe and pervasive speed reductions? This identifies problem areas over quarterly periods and validates sustained performance. For example, every three months, all the major roads are ranked from best to worst based on how much they're slowing down compared to ideal free-flow speeds. This informs which corridors have the worst congestion and whether they're getting better or worse over time. For example, if Street A was ranked #15 last quarter and #12 this quarter, the system is working as traffic flow is improving (less congestion). It provides long-term validation of NCSS-driven system. While daily metrics validate immediate performance (see operational validation metrics of Category 5 above), quarterly ranking validates that NCSS-driven management maintains or improves network performance over months.

### Sustained Performance Validation:

NCSS drives daily operational decisions (Category 2 and 3)
Daily decisions improve corridor speeds over time
Speed Slowdown Ranking measures quarterly trends
Improving rankings confirm NCSS-driven system creates sustained benefits

### Specific Validation:

Tier-1 arterials should show improving or stable rankings (validating arterial priority)
Degrading Tier-1 rankings despite good daily ATSPM→Indicates arterial strategy failing at long time scales

This validates that NCSS-driven traffic management delivers sustained improvement, not just short-term optimization. If stable or sustained improvement is not achieved, the system evaluates the underlying reasons and adjusts accordingly to ensure proper working of the system.

In Category 6 of Layer 4, Advanced Predictive Analytics (future-oriented capabilities) provides forward-looking cascade prediction at network scale is different from operational predictions (e.g., Capacity Trajectory Projection (Category 3) and Arrival Time Prediction (Category 3) which operate at segment/intersection scale. It represents future expansion area for network-wide predictive capabilities.

Network Resolution Time Prediction Accuracy. Assesses predicted time when a hot zone and its complete cascade hierarchy (all Tier-1 and Tier-2 feeder roads) will achieve sustained operational stability below seventy percent capacity for thirty continuous minutes. This metric validates whether the system's tier-based coordination strategies produce expected network-level resolution outcomes. This answers the question: “When will traffic actually clear up?” The system looks at how full the hot zone is right now (from NCSS), measures how many cars are still coming in from feeder roads, and notices if that inflow is decreasing (e.g., rush hour ending). If fewer cars keep coming and the hot zone is letting cars out, the system can predict “traffic will be back to normal by a certain time and stay normal for at least x minutes.” Then it checks if the prediction was right, learning to make better predictions over time.

This metric uses NCSS measurements (C_h(t), C_Tier1(t), C_Tier2(t)) as both input for predictions and validation for actual outcomes. For example, every 10 seconds, NCSS provides current capacity states; every 5 minutes, those states feed into forward projection calculations. The metric extends NCSS from “what is the capacity now?” to “when will capacity achieve sustained stability?” Resolution Time prediction adds the temporal dimension to NCSS's spatial snapshot, creating cascade-aware forecasting that validates whether tier-based interventions produce expected network resolution.

### Layer 5

Turning now to Layer 5, the Traffic Signal Optimization and Execution, upon the completion of the synchronized operational scans and the processing of the software engine that computes all metrics, the system then performs its traffic management features. The system displays on the geospatial grid all of the road segment capacity states by color on a map based setting, but it can also display the real time calculated capacity states which would be indexed or arranged by their applicable tier classifications.

Furthermore, because the system is able to create its own queue traffic signal set up based on the observed road segments capacity states, this information updates all traffic lights and intersection adaptive timing schedules to adjust the coordination of the traffic lights accordingly to the system's calculations.

An example is provided in FIG. 10 which shows a grid of the roads, the hot zones intersections and capacity. This example shows the hot zone intersections identified by location (cross-streets) and capacity for a series of roads in a city. The zone identifies the operational priority level assigned to each intersection based on its measured capacity. For example, as illustrated in FIG. 10, Main St. West is classified as a Tier-1 arterial operating at approximately 72% capacity, corresponding to a Zone 3 priority state that places the segment into the signal optimization queue for proactive intervention. Thus, as can be seen, FIG. 10 displays as follows: column 1 identifies the road segment, column 2 identifies the Tier, column 3 displays the road capacity as a percentage, column 4 identifies the zone (priority level) and column 5 provides the operational interpretation, e.g., normal monitoring, active monitoring, queued for proactive signal optimization, etc. Note the streets on the grid can be color coded for zone identification; FIG. 10 includes the Zone label (Z1 . . . Zn) adjacent the street to facilitate understanding/clarity for purposes of the present disclosure, but in preferred embodiments, the Z1 . . . Zn label would not appear but the display would be identifiable just by the different colors. Different ways/indicia to differentiate the zones are also contemplated.

The system can have in some embodiments additional features such as breaking down or regrouping the geospatial grid into quadrants or other fractional parts in order to be able to bifurcate itself and run distinct and independent strategies in a specific zone, quadrant or local area. (Temporal/Spatial Toggling Management feature). Such features enable toggling between different traffic signal coordination strategies such as decentralized—city wide capacity state balancing and centralized.

The system in some embodiments can have an adaptive traffic signal adjustments and programming to run a calculation that is updated every 2-3 seconds (or other predetermined timing/intervals) during an active green light to determine if the green light can be extended by +15, +30, +45 +60 seconds by computing or scanning every second, or even time durations that are less than a second, if the exact light that is green can be extended if at all, and the other competing lights and road segments would still be maintained within an appropriate capacity threshold—based on a current reading of up flow or cars are moving in and the presence of a low capacity state at the immediate road segment that is paused or has a red light due to its immediate location to a green. It runs these calculations very quickly. Not every light gets extended, and when it makes sense, it can be extended proportionally.

Step 1: Check current segment discharging
IF Current_Capacity > 50% AND Discharge_Rate > threshold:

→ Still has vehicles to clear, extension candidate

Step 2: Check ALL competing segments (waiting at red)
FOR each competing segment j:

IF Capacity_j > 75%:
→ Cannot extend, segment j needs green NOW
IF Wait_Time_j > 180 seconds:
→ Cannot extend, approaching fairness limit

Step 3: Check downstream capacity
IF Downstream_Capacity < 85%:

→ Can accept more flow, extension acceptable

Step 4: Determine extension amount
IF all checks pass:

Extension = f(Current_Capacity, Discharge_Rate, Wait_Times)
Extension ∈ {0, 15, 30, 45, 60} seconds

ELSE:

Extension = 0, terminate green

The system works in the same appropriate fashion for early or premature termination of a green light.

It should be appreciated that intervals, percentages, timing, ranges, etc. are provided in the descriptions above by way of example as other intervals, percentages, timing, ranges, etc. are also contemplated and within the scope of the present invention. Thus, for example, if a percentage of 80% is mentioned/provided or a time of 240 seconds is mentioned/provided, the present invention is not limited to such percentage or timing and the system of the present invention can be configured to conduct its assessments and calculations based on different percentages and/or different timings, and in some embodiments, the system itself can self learn to modify these numerical values of percentages, ranges, timings/intervals, etc. to improve its traffic management operations.

The present invention provides a method of traffic management implementing one or more of the steps represented in the blocks of FIG. 7. The present invention also provides a method of traffic management implementing one or more of the steps represented in the blocks of FIG. 8.

The system of the present invention includes a processor and memory, storing instructions that when executed by the processor, cause the system to receive the data from the sensors, compile the data, evaluate and compute the desired results, and display the results. The present invention also provides a computer-implemented method for generating the desired results to traffic management.

Note the system as discussed above in preferred embodiments includes an artificial intelligence (AI) component which can process input data, learn from interactions and provide specific tailored outputs based on its learning and modeling. The AI component can also utilize prior computations/analyses from previous assessments of the designated area or from other areas, e.g., cities, utilizing the system to assist processing of vehicle and traffic inputs, and in some embodiments the AI components can use permitted information shared among multiple users, learning from multiple users.

The system includes a processor and memory for data interpretation, processing and storage. The processor is a hardware device for executing software instructions and can be a custom made or commercially available processor, a central processing unit (CPU), etc. The processor, pursuant to the software instructions, performs its processing function and communicates data to and from the memory and outputs data to various display devices in various formats including graphic user interfaces, etc. The memory can include any of volatile memory elements, e.g., random access memory (RAM, DRAM, etc.), non volatile memory elements, e.g.

ROM, and combinations thereof.

Various User Interface Platforms and Outputs/displays can be utilized in the system.

Note the system in preferred embodiments achieves all the foregoing objectives, and utilizes all of the aforedescribed Layers, Categories and Metrics, however, it is also contemplated that the system of the present invention could in alternate embodiments provide only some of the foregoing features/objectives, and utilize only some of the aforedescribed Layers, Categories and Metrics, but with its sensor design and placement, vehicle and road interpretation and calculations in a multitiered road system, processing and outputs, coupled with its validation and AI features, still provide advantages over current systems. Further, the Layers and Categories, including various calculations and assessments, timing, scanning intervals, etc. are provided by way of example as other implementations and variations thereof are also envisioned within the scope of the present invention.

One or more steps or stages of the method, process or algorithms described herein (for implementing various functions) can be embodied in hardware, in software executed by a processor or in a combination of both hardware and software and/or other components.

Any communications interface known in the art may be used. Information, or at least a part thereof, in some embodiments could be encrypted.

The AI model can be various models such as a Large Language Model (LLM) by way of example. The AI models can learn from one or more scenarios/system implementation/traffic management outcomes and adapt based on such interactions. Continuous learning improves outcomes/outputs.

In some aspects, disclosed systems comprise computer-readable media, such as non-transitory media, storing executable instructions. In some embodiments, executable instructions are computer-executable instructions, machine-executable instructions, and/or processor-executable instructions comprising computer code. In some embodiments, executable instructions may be executed in a distributed system or cloud-based environment, with parts of the program running on different machines or servers.

Depending on the embodiment, the disclosed components, blocks, modules, steps, stages, and the like, where implemented as executable instructions, such as processor-executable instructions, may be executed by any suitable processor known to those in the art such as a microprocessor or any conventional processor, controller, microcontroller, or state machine. Besides being embodied in software such as processor-executable instructions, one or more steps or stages of any disclosed method, process, or algorithm also may be embodied directly in hardware, or in a combination of both hardware and software and/or other components, and embodiments herein accordingly also may be implemented in hardwired circuitry in place of, or in combination with, machine-executable software instructions.

In some embodiments, one or more steps or stages of any disclosed method, process, or algorithm is embodied in machine-executable instructions, which are performed by a machine. In some embodiments, the machine is a computer system. The computer system, or other machine, may have a set of instructions, such as computer-executable instructions, or other machine-executable instructions, for causing the computer or the machine to perform or execute any one or more of the steps of a disclosed method, according to one or more embodiments. The steps discussed and illustrated in the flow diagrams can be performed in different sequences than shown, provided the resulting outcome is consistent with the objectives of the traffic management systems disclosed herein.

The memory module of the system can provide short term storage and long term storage of data.

The memory described herein can include for example a Random Access Memory (RAM), including SRAM or Dynamic RAM (DRAM), Read Only Memory (ROM)), volatile memory, non-volatile memory, etc.

Aspects of the present invention are described herein with reference to flow charts or block diagrams of methods, systems and computer program products according to embodiments of the present invention. It will be appreciated that the various flow chart illustrations and blocks can be implemented by computer readable program instructions. Additionally, although some of the functions are provided in individual illustrations or blocks, they can overlap and need not be discrete as represented in the diagrams. The present invention includes computer software (e.g., operating systems, application software) for controlling the computing system and enabling the computer system to interact with a human user, e.g., in embodiments with human controlled/input traffic management features/aspects.

While the present invention has been described with reference to the specific embodiments thereof it should be understood by those skilled in the art that various changes may be made and equivalents may be substituted without departing from the spirit and scope of the invention. In addition, many modifications may be made to adopt a particular situation, material, composition of matter, process, process step or steps, to the objective spirit and scope of the present invention. All such modifications are intended to be within the scope of the claims appended hereto.

Where a range of values is provided, it is understood that each intervening value, between the upper and lower limit of that range is encompassed within the invention.

Although the apparatus and methods of the subject invention have been described with respect to preferred embodiments, which constitute non-limiting examples, those skilled in the art will readily appreciate that changes and modifications may be made thereto without departing from the spirit and scope of the present invention as defined by the appended claims.

It will be understood by those skilled in the art that the above particular embodiments are shown and described by way of illustration only. The principles and the features of the present disclosure may be employed in various and numerous embodiments thereof without departing from the scope and spirit of the disclosure as claimed. The above-described embodiments do not restrict the scope of the disclosure.

Additionally, persons skilled in the art will understand that the elements and features shown or described in connection with one embodiment may be combined with those of another embodiment without departing from the scope of the present invention.

Throughout the present disclosure, terms such as “approximately,” “about,” “generally,” “substantially,” and the like should be understood to allow for variations in any numerical range or concept with which they are associated. For example, it is intended that the use of terms such as “approximately,” “about” and “generally” should be understood to encompass variations on the order of 25%, or to allow for manufacturing tolerances and/or deviations in design.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. An adaptive traffic management system comprising:
a) a plurality of sensors at a plurality of road segments for determining vehicle information on a series of road segments;
b) a processor in communication with the sensors, the processor configured to
i) create an initial geospatial grid with a tier road classification;
ii) process data communicated by the sensors of vehicle information on the series of road segments;
iii) calculate vehicle status of the series of roads based on predetermined vehicle capacities; and
iv) adjust select traffic lights on a select series of roads in accordance with calculation and predictive evaluations.

2. The system of claim 1, wherein the series of road segments is for a citywide system and the sensors include at least a sensor in a traffic light and a standalone sensor adjacent the road segment.

3. The system of claim 1, wherein the tier road classification comprises a first tier of arterial roads that feed directly into pre-identified busy intersections, a second tier of feeder roads that feeds directly into the first tier of arterial roads and a third tier of local roads that feeds directly into the second tier of roads.

4. The system of claim 3, wherein the tier road classification further comprises additional tiers of roads cascading outwardly to less busy roads and cascading to a city wide boundary.

5. The system of claim 1, wherein the vehicle information includes a size and type of vehicle, wherein the processor is configured to calculate a number of vehicles that can potentially fit on the road segment to determine a geometric maximum and further calculates the current vehicle count on the road segment to determine a vehicle fullness of the road segment, the vehicle fullness provided as a percentage capacity.

6. The system of claim 5, wherein synchronized capacity threshold scans are performed at first time intervals and synchronized capacity threshold scans are performed at second different time intervals to thereby provide the system with real time updates of road traffic conditions.

7. The system of claim 5, wherein the processor is configured to assign a value to a calculated capacity percentage, and when the value is determined to be above a preset value, feeder roads receive additional green light time.

8. The system of claim 1, wherein adjustment of traffic lights is based on evaluation of both road capacity determination and vehicle wait time on the road segment.

9. The system of claim 8, wherein if the vehicle wait time exceeds a preset value, traffic light changes are initiated.

10. The system of claim 1, wherein the processor is configured to calculate vehicle volume change at synchronized cycle scans to assess traffic flow, wherein at intersections, a validation is performed to assess the difference in a sum of incoming segment outflow rates and a sum of outgoing segment inflow rates.

11. The system of claim 1, wherein the processor is configured to conduct an operational performance validation to assess the accuracy of real time calculated outcomes with predicted outcomes.

12. The system of claim 11, wherein the processor is configured to conduct strategic performance validations at intervals of at least one month to determine if the system is working on a network scale.

13. The system of claim 1, wherein the processor is configured to display on the geospatial grid the road segment capacity states on a map based setting and updates traffic lights and intersection adaptive timing schedules in accordance with calculations.

14. The system of claim 13, wherein in response to a performance validation, the system self learns and adjusts to provide more accurate predictive inputs for subsequent traffic light adjustments.

15. The system of claim 1, wherein the processor is configured to determine if a subset of a set of green lights can be extended for a period of time.

16. The system of claim 1, wherein the processor is configured to calculate simultaneously a vehicle capacity on the road segment and assesses how far congestion propagates from a hot zone to detect how congestion cascades through a network hierarchy.

17. A smart traffic management system comprising:
a) a first sensor positioned in a first traffic light to detect vehicle information,
b) a second sensor remote from the first sensor and positioned adjacent a road segment, the second sensor transmitting data to one or both of the first sensor or remote processor, and the first sensor transmitting data to one or both of the second sensor or remote processor;
c) the processor configured to
i. store data received from the first and second sensor;
ii. process the data to detect current vehicle traffic status of road segments of a geospatial grid representative of multiple road segments cascading from high capacity road segments to lower capacity road segments;
iii. conduct real time capacity scans of the road segments;
iv. visually display real time road segment capacity; and
v. create traffic signal setup based on road segment capacity.

18. The system of claim 17, wherein the processor is configured to conduct an operational performance validation to assess the accuracy of real time calculated outcomes with predicted outcomes.

19. The system of claim 17, wherein the processor is configured to calculate simultaneously a vehicle capacity on the road segment and assesses how far congestion propagates from a hot zone to detect how congestion cascades through a network hierarchy.

20. A method for controlling traffic lights to improve traffic flow comprising:
a) receiving vehicle information of vehicle size and number on a plurality of road segments from a plurality of sensors monitoring the road segments;
b) determining traffic status on the road segments by comparison of the real time vehicle information to pre-calculated vehicle capacity of the road segments;
c) creating traffic signal setup based on the traffic status;
d) conducting updates either continuous or at preset intervals of vehicle capacity on the road segments;
e) assessing vehicle capacity on road segments feeding into other road segments;
f) updating the traffic signals in response to steps d and e.
